(19) United States
(12) Patent Application Publication
(10) Pub. No.: US 2023/0088849 A1
(43) Pub. Date: Mar. 23, 2023

(54) SECONDARY BATTERY, BATTERY PACK, VEHICLE, AND STATIONARY POWER SUPPLY

(71) Applicant: KABUSHIKI KAISHA TOSHIBA, Tokyo (JP)

(72) Inventors: Hayato SEKI, Kawasaki (JP); Keigo HOSHINA, Yokohama (JP)

(73) Assignee: KABUSHIKI KAISHA TOSHIBA, Tokyo (JP)

(21) Appl. No.: 17/652,183

(22) Filed: Feb. 23, 2022

(30) Foreign Application Priority Data
Sep. 17, 2021 (JP) 2021-151854

(51) Int. Cl. H01M 4/485; H01M 10/0525; H01M 4/66; H01M 50/204

(52) U.S. Cl. CPC H01M 4/485; H01M 10/0525; H01M 4/661; H01M 50/204; H01M 2220/20

(57) ABSTRACT

According to one embodiment, provided is a secondary battery including an aqueous electrolyte, a positive electrode, and a negative electrode. The negative electrode includes a negative electrode current collector and a negative electrode active material-containing layer. The negative electrode current collector includes a first metallic substance including one or more element M_{A} selected from Sn, Ni, Cu, Pb, and Ti. A surface of the negative electrode active material-containing layer includes the first metallic substance and a second metallic substance including one or more element M_{B} selected from Hg, Zn, Pb, Sn, Cd, Pd, Al, Bi, and In. A ratio P_{A}/(P_{A}+P_{B}) of an abundance P_{A} of element M_{A} and an abundance P_{B} of element M_{B} on the surface of the negative electrode active material-containing layer is 0.01 or more.

### CROSS-REFERENCE TO RELATED APPLICATIONS

This application is based upon and claims the benefit of priority from Japanese Patent Application No. 2021-151854, filed Sep. 17, 2021, the entire contents of which are incorporated herein by reference.

### FIELD

Embodiments described herein relate generally to a secondary battery, a battery pack, a vehicle, and a stationary power supply.

### BACKGROUND

A nonaqueous electrolyte battery formed by using a carbon material or a lithium titanium oxide as a negative electrode active material and a layered oxide that contains nickel, cobalt or manganese as a positive electrode active material, particularly a lithium secondary battery has already been in practical use as a power source in a wide range of fields. Such a nonaqueous electrolyte battery is provided in a variety of forms, such as small-sized batteries for various electronic devices and large-sized batteries for electric automobiles. For an electrolytic solution of the lithium secondary battery, a nonaqueous organic solvent prepared by mixing ethylene carbonate, methylethyl carbonate and the like is used, unlike a nickel-hydrogen battery or a lead storage battery. An electrolytic solution prepared using such a solvent has a higher oxidation resistance and a higher reduction resistance as compared to those of an aqueous electrolytic solution, whereby electrolysis of the solvent hardly occurs. Thus, with a nonaqueous lithium secondary battery, a high electromotive force of from 2 V to 4.5 V is attained.

Meanwhile, many organic solvents are flammable substances. Accordingly, the safety of a secondary battery formed using an organic solvent is theoretically inferior to that of a secondary battery formed using an aqueous solution. In order to improve the safety of a lithium secondary battery formed using an electrolytic solution containing an organic solvent, various countermeasures have been made; however, one cannot be certain that the countermeasures are sufficient. Furthermore, in the production process of the nonaqueous lithium secondary battery, a dry environment is necessary, thereby inevitably increasing the production cost. In addition, the electrolytic solution containing an organic solvent is inferior in electrical conductivity, whereby an internal resistance of the nonaqueous lithium secondary battery is easily increased. Such problems are large defects for applying to use in electric vehicles or hybrid electric vehicles and large-sized storage batteries for stationary energy storage, where there is emphasis on the battery safety and cost.

In order to resolve the problems found in nonaqueous secondary batteries, secondary batteries using an aqueous solution electrolyte have been proposed. However, due to electrolysis of the aqueous solution electrolyte, the active material is apt to fall off the current collector, and therefore, operation of the secondary battery had not stabilized, posing a problem against satisfactory charge and discharge. In order to perform satisfactory charge and discharge, in the case an aqueous solution electrolyte is used, the potential range for performing charge and discharge of the battery must be limited to a potential range at which an electrolysis reaction of water contained as a solvent does not occur. For example, by using a lithium manganese oxide as the positive electrode active material and using a lithium vanadium oxide as the negative electrode active material, electrolysis of aqueous solvent can be avoided. In the case of such a combination, while an electromotive force of from 1 V to 1.5 V can be obtained, an energy density sufficient as a battery is hardly obtained.

As another combination, when a lithium manganese oxide is used as the positive electrode active material and a lithium titanium oxide such as LiTi₂O₄ or Li₄Ti₅O₁₂ is used as the negative electrode active material, an electromotive force of about 2.6 V to 2.7 V can be theoretically obtained, and the battery may also be attractive from the viewpoint of energy density. With a nonaqueous lithium ion battery adopting such a combination of the positive and negative electrode materials, excellent life performance is obtained and such a battery has already been in practical use.

However, in the aqueous solution electrolyte, a lithium insertion/extraction potential of lithium titanium oxide is about 1.5 V (vs. Li/Li⁺) based on lithium potential, and thus, electrolysis of the aqueous solution electrolyte easily occurs. For the negative electrode in particular, hydrogen is vigorously generated by electrolysis on the surface of a negative electrode current collector or a metal outer can electrically connected to the negative electrode. Due to an influence thereof, the active material is apt to fall off the current collector. Consequently, operation does not stabilize in such a battery, whereby satisfactory charge-discharge cycle had not been possible.

Many titanium-containing oxides including spinel-type lithium titanium oxide Li₄Ti₅O₁₂ (LTO) have lower operating potentials than the electrolysis potential of water. Thus, for example, in a secondary battery using a titanium-containing oxide such as LTO as a negative electrode active material and containing a large amount of water in the electrolytic solution, not only does the negative electrode active material fall off due to bubbles of hydrogen generated by electrolysis of water, but also, an insertion reaction of carriers (for example, alkali metal ions such as lithium ions) into the negative electrode active material and a reduction reaction of protons (hydrogen cation; H⁺) by electrolysis of water compete. As a result, the charge-discharge efficiency and the discharge capacity of the secondary battery deteriorate.

### BRIEF DESCRIPTION OF THE DRAWINGS

FIG. 1 is a sectional view schematically showing an example of a secondary battery according to an embodiment;

FIG. 2 is a sectional view of the secondary battery shown in FIG. 1 taken along a line II-II;

FIG. 3 is a partially cut perspective view schematically showing another example of the secondary battery according to the embodiment;

FIG. 4 is an enlarged sectional view showing section E of the secondary battery shown in FIG. 3;

FIG. 5 is a perspective view schematically showing an example of a battery module according to an embodiment;

FIG. 6 is a perspective view schematically showing an example of a battery pack according to an embodiment;

FIG. 7 is an exploded perspective view schematically showing another example of the battery pack according to the embodiment;

FIG. 8 is a block diagram showing an example of an electric circuit of the battery pack shown in FIG. 7;

FIG. 9 is a partially see-through diagram schematically showing an example of the vehicle according to an embodiment;

FIG. 10 is a block diagram showing an example of a system including the stationary power supply according to an embodiment; and

FIG. 11 is an illustrative overview of aging treatments in examples and comparative examples.

### DETAILED DESCRIPTION

According to one embodiment, provided is a secondary battery including an aqueous electrolyte, a positive electrode in contact with the aqueous electrolyte, and a negative electrode in contact with the aqueous electrolyte. The negative electrode includes a negative electrode current collector and a negative electrode active material-containing layer provided on the negative electrode current collector. The negative electrode current collector includes a first metallic substance. A surface of the negative electrode active material-containing layer includes the first metallic substance and a second metallic substance. The first metallic substance includes one or more first metallic element M_{A} selected from the group consisting of Sn, Ni, Cu, Pb, and Ti. The second metallic substance includes one or more second metallic element M_{B} selected from the group consisting of Hg, Zn, Pb, Sn, Cd, Pd, Al, Bi, and In. A ratio P_{A}/(P_{A}+P_{B}) of an abundance P_{A} of the first metallic element M_{A} and an abundance P_{B} of the second metallic element M_{B} on the surface of the negative electrode active material-containing layer is 0.01 or more.

According to another embodiment, a battery pack including the secondary battery according to the above embodiment is provided.

According to yet another embodiment, a vehicle including the battery pack according to the above embodiment is provided.

According to still another embodiment, a stationary power supply including the battery pack according to the above embodiment is provided.

When the negative electrode current collector includes zinc, hydrogen generation at the negative electrode current collector can be suppressed. This is because zinc has a high hydrogen generation overvoltage because of its small exchange current density. In addition, it is known that by charge and discharge of a secondary battery including a negative electrode with zinc included in the current collector under specific conditions, a coating film including zinc can be formed on the surface of the negative electrode, whereby the effect of suppressing hydrogen generation can be further enhanced by the coating film. The coating film is formed by zinc that has eluted from the current collector depositing onto the surface of the negative electrode upon charge and discharge of the battery.

However, due to elution of zinc from the current collector, adhesion between the negative electrode current collector and a negative electrode active material diminishes. As a result, the electrical resistance of the negative electrode increases, whereby the charge-discharge efficiency of the secondary battery may decrease or the life may shorten.

Hereinafter, embodiments will be described with reference to the drawings. The same reference signs are applied to common components throughout the embodiments and overlapping explanations are omitted. Each drawing is a schematic view for explaining the embodiment and promoting understanding thereof; though there may be differences in shape, size and ratio from those in an actual device, such specifics can be appropriately changed in design taking the following explanations and known technology into consideration.

### First Embodiment

According to a first embodiment, a secondary battery is provided. The secondary battery includes an aqueous electrolyte, a positive electrode and a negative electrode. The positive electrode and the negative electrode are in contact with the aqueous electrolyte. The negative electrode includes a negative electrode current collector and a negative electrode active material-containing layer provided thereon. The negative electrode current collector includes a first metallic substance. The first metallic substance includes one or more first metallic element M_{A} selected from the group consisting of Sn, Ni, Cu, Pb, and Ti. The negative electrode active material-containing layer includes the first metallic substance and a second metallic substance on a surface thereof. The second metallic substance includes one or more second metallic element M_{B} selected from the group consisting of Hg, Zn, Pb, Sn, Cd, Pd, Al, Bi, and In. A ratio P_{A}/(P_{A}+P_{B}) of an abundance P_{A} of the first metallic element M_{A} and an abundance. P_{B} of the second metallic element M_{B} on the surface of the negative electrode active material-containing layer is 0.01 or more.

For the above-described secondary battery, self-discharge is suppressed, and thus, charge-discharge efficiency is excellent. Further, the above-described secondary battery has a small capacity reduction rate upon repetition of charge and discharge, and is therefore excellent in life performance.

The secondary battery may be an alkaline secondary battery, for example. Specifically, the battery may be a lithium secondary battery (lithium ion secondary battery). The secondary battery may be, for example, a sodium secondary battery (sodium ion secondary battery). The secondary battery includes an aqueous electrolyte secondary battery containing an aqueous electrolyte (for example, an aqueous solution electrolyte). In other words, the secondary battery may be an aqueous electrolyte lithium ion secondary battery, or an aqueous electrolyte sodium ion secondary battery.

The secondary battery may further include a separator provided between the positive electrode and the negative electrode. The negative electrode, the positive electrode, and the separator may configure an electrode group. The aqueous electrolyte may be held in the electrode group. The secondary battery may further include a container member capable of housing the electrode group and the aqueous electrolyte. In addition, the secondary battery may further include a negative electrode terminal electrically connected to the negative electrode and a positive electrode terminal electrically connected to the positive electrode.

The negative electrode includes a negative electrode current collector and a negative electrode active material-containing layer provided on the negative electrode current collector. The negative electrode active material-containing layer is provided on at least one surface of the negative electrode current collector. For example, the negative electrode active material-containing layer may be provided on one face of the negative electrode current collector, or the negative electrode active material-containing layer may be arranged on one face of the negative electrode current collector and a reverse face thereto.

The negative electrode current collector contains one or more first metallic element M_{A} selected from the group consisting of Sn, Ni, Cu, Pb, and Ti. These first metallic elements M_{A} are hereinafter also referred to as elements A. These elements A may be used singly or in combination of plural species. The elements A may be contained as metals or metal alloys. Such metals and metal alloys may be contained singly or in combination of two or more. When these elements A are contained in the current collector, the mechanical strength of the current collector is enhanced and the processing performance is improved. Further, the elements A provide the effects of suppressing electrolysis of an aqueous solvent contained in the aqueous electrolyte, thereby suppressing hydrogen generation. Among the above-mentioned elements A, Sn, Ni, and Cu are more preferable.

The negative electrode current collector may be a metal foil formed of a metal of the element A, for example. Alternatively, the negative electrode current collector may be a metal-alloy foil formed of a metal alloy containing the element A, for example. Examples of the shape of the current collector include a mesh and a porous body, in addition to a foil. From the viewpoint of improving the energy density and output, a foil shape is desirable because of its small volume and large surface area.

The negative electrode current collector may also contain the element A (first metallic element M_{A}) in the form other than a metal or an alloy. Specifically, the negative electrode current collector may contain one or more compound selected from the group consisting of an oxide, a hydroxide, a basic carbonate compound, and a sulfate compound of the element A, for example. An oxide of the element A and/or a hydroxide of the element A and/or a basic carbonate compound of the element A and/or a sulfate compound of the element A are preferably contained in at least a part of a surface of the current collector in a region at a depth of 5 nm or more and 1 μm or less in the depth direction from the surface.

When at least one of an oxide of the element A, a hydroxide of the element A, a basic carbonate compound of the element A, and a sulfate compound of the element A is present in the surface layer portion of the current collector, there is observed improvement in adhesion between the current collector and a constituent material of the active material-containing layer (an active material, an electro-conductive agent, a binder, and the like), in addition to suppression of hydrogen generation in the same manner as is observed when the element A is present in the form of a metal or an alloy. As a result, the number of paths of electron conduction can be increased, which enables further improvement in life performance and reduction in electrical resistance.

A sole metallic element, an alloy, and a compound of the first metallic element M_{A} (element A) are collectively referred to as a first metallic substance. In other words, the first metallic substance includes at least one of the first metallic element M_{A}, an alloy containing the first metallic element M_{A}, and a compound of the first metallic element M_{A}. The compound of the first metallic element M_{A} includes at least one selected from the group consisting of an oxide of the first metallic element M_{A}, a hydroxide of the first metallic element M_{A}, a basic carbonate compound of the first metallic element M_{A}, and a sulfate compound of the first metallic element M_{A}. The negative electrode current collector may include a combination of the first metallic substances in plural forms. A specific example thereof is a current collector in which a metal foil formed of the first metallic element M_{A} or an alloy foil containing the first metallic element M_{A} is used as a substrate and a compound of the first metallic element M_{A} is provided in at least a part of the surface layer of the substrate.

The first metallic substance exhibits a dissolution level of 50% or less for dissolution in the aqueous electrolyte at a potential of −1.2 V (vs. SCE) with respect to a standard calomel electrode. Since the first metallic substance, which is a constituent material of the negative electrode current collector, hardly dissolves in the electrolyte, binding between the negative electrode current collector and the negative electrode active material-containing layer can be maintained even if the negative electrode is exposed to a relatively high potential. Among the first metallic substances, a material (a metal, an alloy, or a compound) having a dissolution level of 10% or less at the above-mentioned potential is preferably used, and a material having a dissolution level of 1% or less is more preferably used.

Further, the negative electrode current collector may include a substrate containing a metal different from the first metallic element M_{A}. In such a case, presence of the first metallic substance in at least a part of the surface of the substrate can suppress hydrogen generation. The first metallic substance present at the surface is desirably present at a position in contact with the negative electrode active material-containing layer. The first metallic substance may be provided in the surface of the substrate by plating the substrate with the first metallic element M_{A}, for example. Alternatively, the surface of the substrate may be subjected to plating using an alloy containing the first metallic element M_{A}.

The substrate containing a metal different from the first metallic element M_{A} preferably includes at least one metal selected from the group consisting of Zn and Al. These metals may also be contained as alloys. In addition, the substrate may contain such metals or metal alloys singly or in combination of two or more thereof.

The negative electrode active material-containing layer contains a negative electrode active material. The negative electrode active material-containing layer may contain an electro-conductive agent, a binder, and the like in addition to the negative electrode active material. The electro-conductive agent has a function of enhancing the current collecting performance of the negative electrode and suppressing the contact resistance between the negative electrode active material and the negative electrode current collector. The binder has a function of binding the negative electrode active material, the electro-conductive agent, and the negative electrode current collector.

The negative electrode active material-containing layer contains the first metallic substance on a surface thereof. The negative electrode active material-containing layer further contains one or more second metallic element M_{B} selected from the group consisting of Hg, Zn, Pb, Sn, Cd, Pd, Al, Bi, and In. The second metallic element M_{B} is contained on the surface of the active material-containing layer in the form of a second metallic substance including at least one of the second metallic element M_{B}, an alloy containing the second metallic element M_{B}, and a compound of the second metallic element M_{B}. The compound of the second metallic element M_{B} includes at least one selected from the group consisting of an oxide of the second metallic element M_{B}, a hydroxide of the second metallic element M_{B}, a basic carbonate compound of the second metallic element M_{B}, and a sulfate compound of the second metallic element M_{B}. Like the first metallic substance, the second metallic substance provides the effect of suppressing electrolysis of an aqueous solvent, thereby suppressing hydrogen generation.

The first metallic substance on the surface of the negative electrode active material-containing layer may be, for example, a first metallic substance, which had been contained in the negative electrode current collector, that had eluted and then deposited onto the surface of the negative electrode active material-containing layer by aging in the secondary battery manufacturing method described later. That is, the first metallic substance contained in the surface of the negative electrode active material-containing layer corresponds to the first metallic substance contained in the negative electrode current collector. The second metallic substance may be, for example, an additive containing the second metallic element M_{B}, which had been added to the aqueous electrolyte, that has deposited onto the surface of the negative electrode active material-containing layer by aging described later. Further, the first metallic substance and the second metallic substance may be metal powder contained in the active material-containing layer as an electro-conductive agent as described later.

The first metallic element M_{A} contained in the first metallic substance on the surface of the negative electrode active material-containing layer and the second metallic element M_{B} contained in the second metallic substance are not the same with each other. Even if plural of metals, alloys, and metallic compounds are contained in the surface of the negative electrode active material-containing layer, in a case where the metal (s) contained therein match with any of the first metallic elements M_{A} such as Sn and Pb contained in the negative electrode current collector, the corresponding metals, alloys, and metallic compounds are all regarded as the first metallic substances.

The first metallic substance and the second metallic substance in the surface of the negative electrode active material-containing layer are present in proportions with which a ratio P_{A}/P_{A}+P_{B}) of an abundance P_{A} of the first metallic element M_{A} to the sum of the abundance P_{A} of the first metallic element M_{A} and an abundance P_{B} of the second metallic element M_{B} in the surface of the negative electrode active material-containing layer is 0.01 or more. The first metallic substance and the second metallic substance are preferably present in the surface of the negative electrode active material-containing layer in proportions at which the ratio P_{A}/(P_{A}+P_{B}) is 0.05 or more, and more preferable proportions are those where the ratio P_{A}/(P_{A}+P_{B}) is 0.1 or more. As described above, the first metallic substance is not apt to dissolve in the aqueous electrolyte. The negative electrode potential may fluctuate between a relatively high value and a low value as the secondary battery is charged and discharged. On one hand, since a dissolution reaction of the first metallic substance at a high potential is not apt to occur, a certain amount or more of the first metallic substance can be retained on the negative electrode active material-containing layer. On the other hand, at a low potential, it is possible to suppress electrolysis reaction of water that is a side reaction that proceeds mainly in the surface of the negative electrode.

Further, the first metallic substance and the second metallic substance are preferably contained in the surface of the negative electrode active material-containing layer in proportions at which the ratio P_{A}/(P_{A}+P_{B}) is 0.5 or less. As described above, the first metallic substance contained in the surface of the negative electrode active material-containing layer may be a substance eluted from the negative electrode current collector at the time of manufacturing the secondary battery. The ratio P_{A}/(P_{A}+P_{B}) of 0.5 or less means that metal elution from the negative electrode current collector at the time of manufacturing is kept moderate. Thus, the adhesion between the negative electrode active material-containing layer and the negative electrode current collector is maintained in the negative electrode, and an increase in electric resistance is suppressed.

The surface of the negative electrode active material-containing layer is desirably covered with the first metallic substance and the second metallic substance at a coverage (area ratio) of 5% or more and 90% or less in total. By virtue of the low hydrogen generation potential of the first metallic substance and the second metallic substance, the hydrogen generation overvoltage increases in the secondary battery that uses the negative electrode including a coating of those substances. When the first metallic substance and the second metallic substance are sufficiently deposited on the surface of the negative electrode active material-containing layer, it is possible to suppress electrolysis reaction of water on the surface of the negative electrode and thus suppress hydrogen generation following electrolysis reaction. Thus, when the coverage of the negative electrode active material-containing layer with the first metallic substance and the second metallic substance is 5% or more, the charge-discharge efficiency is increased. In addition, since generation of hydrogen gas in the battery can be suppressed, hindering of formation of an interface between the electrode and the electrolytic solution due to generation of gas are reduced, whereby the life performance is improved, as well. Meanwhile, excessive coating with the first metallic substance and the second metallic substance can lead to an increase in electrical resistance of the negative electrode. Therefore, by setting the coverage to 90% or less, it is possible to maintain the electrical conductivity of the negative electrode.

In the negative electrode containing the first metallic substance and the second metallic substance in the above-mentioned forms, the hydrogen generation potential may be −0.5 V (vs. SCE) or less. The hydrogen generation potential in the negative electrode is preferably −0.8 V (vs. SCE) or less, and more preferably −1.1 V (vs. SCE) or less. Such a low hydrogen generation potential means that a reduction current is not apt to flow in the negative electrode, which in turn means that decomposition reaction of the electrolyte hardly proceeds. Thus, the low hydrogen generation potential increases the charge-discharge efficiency of the secondary battery as described above, and also suppresses gas generation, thereby improving the life performance.

Hereinafter, the negative electrode, the positive electrode, the aqueous electrolyte, the separator, the container member, the negative electrode terminal, and the positive electrode terminal will be described in detail.

(1) Negative Electrode

The negative electrode includes the above-described negative electrode current collector and the negative electrode active material-containing layer provided on the current collector.

The negative electrode active material-containing layer contains a negative electrode active material including at least one compound selected from the group consisting of an oxide of titanium, a lithium-titanium oxide, and a lithium-titanium composite oxide, for example. Examples of the lithium-titanium composite oxide include a niobium-titanium composite oxide and a sodium-niobium-titanium composite oxide. Those oxides may be used singly or in combination of plural species. In those oxides, Li insertion/extraction reaction occurs within a range of 1 V or more and 3 V or less (vs. Li/Li⁺) with respect to a lithium potential and within a range of −2.28 V or more and −0.28 V or less (vs. SCE) with respect to the potential of the standard calomel electrode. Thus, when those oxides are used as the negative electrode active material of the secondary battery, a long life can be realized because of a small change in their volume expansion/contraction in response to charge and discharge.

Examples of the oxide of titanium include a titanium oxide having a monoclinic structure, a titanium oxide having a rutile structure, and a titanium oxide having an anatase structure. With regard to the titanium oxide having each crystal structure, the composition before charge can be represented as TiO₂, and the composition after charge can be represented as LiₓTiO₂ (the subscript x is within a range of 0≤x≤1). Further, the composition of the titanium oxide having a monoclinic structure before charge can be represented as TiO₂(B).

Examples of the lithium-titanium composite oxide include a lithium-titanium oxide having a spinel structure (a compound represented by a general formula Li_{4+y}Ti₅O₁₂ and having the subscript y within a range of −1≤y≤3, for example), a lithium-titanium oxide having a ramsdellite structure (a compound represented by Li_{2+y}Ti₃O₇ and having the subscript y within a range of −1≤y≤3, for example), a compound represented by Li₁₊ₓTi₂O₄ and having the subscript x within a range of 0≤x≤1, a compound represented by Li_{1.1+x}Ti_{1.8}O₄ and having the subscript x within a range of 0≤x≤1, a compound represented by Li_{1.07+x}Ti_{1.86}O₄ and having the subscript x within a range of 0≤x≤1, a compound represented by Li_{z}TiO₂ and having the subscript z within a range of 0<z≤1, and the like.

Examples of the niobium-titanium oxide include a compound represented by LiᵥTiM1_{w}Nb_{2±β}O_{7±σ} in which the subscripts are within ranges of 0≤v≤5, 0≤w≤0.3, 0≤β≤0.3, and 0≤σ≤0.3, respectively, and M1 includes at least one selected from the group consisting of Fe, V, Mo, and Ta.

Examples of the sodium-niobium-titanium composite oxide include an orthorhombic Na-containing niobium-titanium composite oxide represented by a general formula Li₂₊ₐNa_{2-b}M2_{c}Ti_{6-d-e}Nb_{d}M3ₑO_{14+δ} in which the subscripts are in ranges of 0≤a≤4, 0<b<2, 0≤c<2, 0<d<6, 0≤e<3, d+e<6, and −0.5≤δ≤0.5, respectively, M2 includes at least one selected from the group consisting of Cs, K, Sr, Ba, and Ca, and M3 includes at least one selected from the group consisting of Zr, Sn, V, Ta, Mo, W, Fe, Co, Mn, and Al.

Examples of a compound preferable as the negative electrode active material include a titanium oxide having an anatase structure, a titanium oxide having a monoclinic structure, and a lithium-titanium oxide having a spinel structure. By having a Li insertion potential of 1.4 V (vs. Li/Li⁺) or more and 2 V (vs. Li/Li⁺) or less or by having a standard calomel electrode potential of −1.88 V (vs SCE) or more and −1.28 V (vs SCE) or less, each compound can provide high electromotive force when combined with lithium-manganese oxide used as a positive electrode active material, for example. Among those compounds, the lithium-titanium oxide having a spinel structure is more preferable because of extremely small change in its volume in response to charge/discharge reaction.

The negative electrode active material may be contained in the negative electrode active material-containing layer in the form of particles. The particles of the negative electrode active material may be primary particles alone, secondary particles corresponding to agglomerated primary particles, or a mixture of primary particles and secondary particles. The shape of each particle is not limited to any particular shape, and may be, for example, spherical, elliptical, flat, fibrous, or the like.

The average particle size (diameter) of the secondary particles of the negative electrode active material is preferably 3 μm or more. A more preferable average secondary particle size is 5 μm or more and 20 μm or less. Within this range, the surface area of the active material is small, and thus, the effect of suppressing hydrogen generation can be enhanced.

The negative electrode active material including the secondary particles having an average particle size of 3 μm or more is obtained by the following method, for example. First, raw materials for the active material are reacted and synthesized to prepare active material precursors having an average particle size of 1 μm or less. Thereafter, the active material precursors are subjected to firing, and pulverization is performed using a pulverizer such as a ball mill or a jet mill. Subsequently, in firing, the active material precursors are agglomerated and grown into the secondary particles having a large particle size.

The primary particles of the negative electrode active material desirably have an average particle size of 1 μm or less. Thereby, the diffusion distance of Li ions inside the active material is shortened, and the specific surface area is larger. Thus, significantly high input performance (rapid charging performance) can be obtained. On the other hand, when the average particle size is small, aggregation of the particles is more likely to occur, whereby the distribution of the electrolyte becomes inclined toward the negative electrode, and the electrolyte may consequently be exhausted at the positive electrode. For this reason, the lower limit is desirably set to 0.001 μm. A more preferable average particle size is 0.1 μm or more and 0.8 μm or less.

The particles of the negative electrode active material desirably have a specific surface area of 3 m²/g or more and 200 m²/g or less as measured by BET method using N₂ adsorption. Thereby, the affinity between the negative electrode and the electrolyte can be further enhanced.

The negative electrode active material-containing layer (excluding the current collector) has a specific surface area within a range of 3 m²/g or more and 50 m²/g or less. A more preferable range of the specific surface area is 5 m²/g or more and 50 m²/g or less. The negative electrode active material-containing layer may be a porous layer containing the negative electrode active material, the electro-conductive agent, and the binder, where the layer is supported on the current collector.

The negative electrode (excluding the current collector) desirably has a porosity within a range of 20% to 50%. Thereby, a high-density negative electrode having excellent affinity between the negative electrode and the electrolyte can be obtained. A more preferable range of the porosity is 25% to 40%.

Examples of the electro-conductive agent include carbon materials such as acetylene black, carbon black, coke, carbon fibers (including carbon nanofibers, carbon nanotubes, and the like), and graphite, and metal powder such as those of nickel and zinc. The above-mentioned electro-conductive agent may be used singly or in combination of two or more. A metal powder is desirably used as the electro-conductive agent because the carbon materials generate hydrogen therefrom.

Examples of the binder include polytetrafluoroethylene (PTFE), polyvinylidene fluoride (PVdF), fluororubber, ethylene-butadiene rubber, polypropylene (PP), polyethylene (PE), carboxymethyl cellulose (CMC), polyimide (PI), polyacrylimide (PAI), and the like. The above-mentioned binder may be used singly or in combination of two or more.

The blending ratios of the negative electrode active material, the electro-conductive agent, and the binder in the negative electrode active material-containing layer are preferably in respective ranges of 70 mass % or more and 95 mass % or less for the negative electrode active material, 3 mass % or more and 20 mass % or less for the electro-conductive agent, and 2 mass % or more and 10 mass % or less for the binder. When the blending ratio of the electro-conductive agent is 3 mass % or more, the electrical conductivity of the negative electrode can be improved, and when the blending ratio is 20 mass % or less, decomposition of the electrolyte on the surface of the electro-conductive agent can be reduced. When the blending ratio of the binder is 2 mass % or more, sufficient electrode strength can be obtained, and when the blending ratio is 10 mass % or less, the electrical resistance of the electrode can be reduced.

The negative electrode can be fabricated as follows, for example. First, the negative electrode active material, the electro-conductive agent, and the binder are dispersed in an appropriate solvent to prepare a slurry. The slurry is applied onto a current collector, and the resultant coating film is dried to form a negative electrode active material-containing layer on the current collector. Here, for example, the slurry may be applied onto one surface of the current collector, or the slurry may be applied onto one surface and the reverse surface of the current collector. Subsequently, the current collector and the negative electrode active material-containing layer are subjecting to pressing, such as hot pressing, for example, whereby a negative electrode can be fabricated. Furthermore, aging described later is performed, thereby forming the first metallic substance and the second metallic substance on the surface of the negative electrode active material-containing layer.

(2) Positive Electrode

The positive electrode includes a positive electrode current collector and a positive electrode active material-containing layer provided on the positive electrode current collector. The positive electrode active material-containing layer is provided on at least one surface of the positive electrode current collector. For example, the positive electrode active material-containing layer may be provided on one face of the positive electrode current collector, or the positive electrode active material-containing layer may be arranged on one face of the positive electrode current collector and a reverse face thereto. The positive electrode active material-containing layer contains a positive electrode active material, and may optionally further contain an electro-conductive agent and a binder.

Preferably used as the positive electrode current collector is a foil, porous structure, or mesh made of a metal such as stainless steel, Al, or Ti. In order to prevent corrosion of the current collector caused by reaction of the current collector with the electrolyte, the surface of the current collector may be covered with another element.

As the positive electrode active material, there may be used a material capable of having lithium and sodium be inserted and extracted. The positive electrode may include one species of positive electrode active material, or include two or more species of positive electrode active materials.

Examples of the positive electrode active material include a lithium manganese composite oxide, a lithium nickel composite oxide, a lithium cobalt aluminum composite oxide, a lithium nickel cobalt manganese composite oxide, a lithium manganese nickel composite oxide with a spinel structure, a lithium manganese cobalt composite oxide, a lithium iron oxide, a lithium fluorinated iron sulfate, a phosphate compound having an olivine crystal structure (for example, a compound represented by LiₓFePO₄ and having the subscript x within a range of 0≤x≤1, or a compound represented by LiₓMnPO₄ and having the subscript x within a range of 0≤x≤1), and the like. The phosphate compound having an olivine crystal structure has excellent thermal stability.

Examples of the positive electrode active material with which a high positive electrode potential can be obtained are described below. Examples include lithium manganese composite oxides such as LiₚMn₂O₄ having a spinel structure where 0<p≤1, or LiₚMnO₂ where 0<p≤1; a lithium nickel aluminum composite oxide such as LiₚNi_{1-q}Al_{q}O₂ where 0<p≤1 and 0<q≤1; lithium cobalt composite oxides such as LiₚCoO₂ where 0<p≤1; lithium nickel cobalt composite oxides such as LiₚNi_{1-q-r}Co_{q}MnᵣO₂ where 0<p≤1, 0<q≤1, and 0≤r≤1; lithium manganese cobalt composite oxides such as LiₚMn_{q}Co_{1-q}O₂ where 0<p≤1 and 0<q≤1; spinel lithium manganese nickel composite oxides such as LiₚMn₂₋ₛNiₛO₄ wherein 0<p≤1 and 0<s<2; lithium phosphates having an olivine structure such as LiₚFePO₄ where 0<p≤1, LiₚFe₁₋ᵣMnᵣPO₄ where 0<p≤1 and 0≤r≤1, or LiₚCoPO₄ where 0<p≤1; fluorinated iron sulfates such as LiₚFeSO₄F where 0<p≤1, and the like.

Further examples of the positive electrode active material include sodium manganese composite oxide, sodium nickel composite oxide, sodium cobalt composite oxide, sodium nickel cobalt manganese composite oxide, sodium iron composite oxide, sodium phosphate compounds (for example, sodium iron phosphate and sodium vanadium phosphate), sodium iron manganese composite oxide, sodium nickel titanium composite oxide, sodium nickel iron composite oxide, and sodium nickel manganese composite oxide.

Examples of a preferable positive electrode active material include iron composite oxides (for example, NaᵣFeO₂ where 0≤r≤1), iron manganese composite oxides (for example, NaᵣFe₁₋ₜMnₜO₂ where 0<t<1, 0≤r≤1), nickel titanium composite oxide (for example, NaᵣNi₁₋ₜTiₜO₂ where 0<t<1, 0 ≤r≤1), a nickel iron composite oxide (for example, NaᵣNi₁₋ₜFeₜO₂ where 0<t<1, 0≤r≤1), nickel-manganese composite oxide (for example, NaᵣNi₁₋ₜMnₜO₂ where 0<t<1, 0≤t≤1), nickel manganese iron composite oxide (for example, NaᵣNi₁₋ₜ₋ᵤMnₜFeᵤO₂ where 0<t<1, 0≤r≤1, 0<u<1, 0<1−t−u<1), iron phosphate (for example, NaᵣFePO₄ where 0≤r≤1).

The particles of the positive electrode active material may be primary particles alone, secondary particles corresponding to agglomerated primary particles, or a mixture of both the solitary primary particles and the secondary particles. The primary particles of the positive electrode active material preferably have an average particle size (a diameter) of 10 μm or less, more preferably from 0.1 μm to 5 μm. The secondary particles of the positive electrode active material preferably have an average particle size (a diameter) of 100 μm or less, more preferably from 10 μm to 50 μm.

At least a part of the particle surface of the positive electrode active material is preferably covered with a carbon material. The carbon material may be in the form of a layered structure, a particulate structure, or a form of agglomerated particles.

As the electro-conductive agent for increasing the electron conductivity of the positive electrode active material-containing layer and suppressing contact resistance between the active material-containing layer and the current collector, examples include acetylene black, carbon black, graphite, carbon fibers (including carbon nanofibers, carbon nanotubes, and the like) having an average fiber diameter of 1 μm or less, and the like. The above-mentioned electro-conductive agent maybe used singly or in combination of two or more.

Examples of the binder for binding the active material to the electro-conductive agent include polytetrafluoroethylene (PTFE), polyvinylidene fluoride (PVdF), fluororubber, ethylene-butadiene rubber, styrene-butadiene rubber (SBR), polypropylene (PP), polyethylene (PE), carboxymethyl cellulose (CMC), polyimide (PI), and polyacrylimide (PAI). The above-mentioned binder may be used singly or in combination of two or more.

The blending ratio of the positive electrode active material, the electro-conductive agent, and the binder in the positive electrode active material-containing layer are preferably in respective ranges of 70 mass % or more and 95 mass % or less for the positive electrode active material, 3 mass % or more and 20 mass % or less for the electro-conductive agent, and 2 mass % or more and 10 mass % or less for the binder. When the blending ratio of the electro-conductive agent is 3 mass % or more, the electrical conductivity of the positive electrode can be improved, and when the blending ratio is 20 mass % or less, decomposition of the electrolyte on the surface of the electro-conductive agent can be reduced. When the blending ratio of the binder is 2 mass % or more, sufficient electrode strength can be obtained, and when the blending ratio is 10 mass % or less, the electrical resistance of the electrode can be reduced.

The positive electrode can be fabricated as follows, for example. First, the positive electrode active material, the electro-conductive agent, and the binder are dispersed in an appropriate solvent to prepare a slurry. The slurry is applied onto a current collector, and the resultant coating film is dried to form a positive electrode active material-containing layer on the current collector. Here, for example, the slurry may be applied onto one surface of the current collector, or the slurry may be applied onto one surface and the reverse surface of the current collector. Subsequently, the current collector and the positive electrode active material-containing layer are subjecting to pressing, such as hot pressing, for example, whereby a positive electrode can be fabricated.

(3) Aqueous Electrolyte

The aqueous electrolyte may be a liquid aqueous electrolyte containing an aqueous solvent and lithium salt as electrolyte salt, for example. The electrolyte may be a gel aqueous electrolyte formed as a composite of a liquid aqueous electrolyte and a polymeric material.

The aqueous electrolyte is in contact with the positive electrode and the negative electrode. The aqueous electrolyte may be held in the positive electrode and the negative electrode. Alternatively, the aqueous electrolyte may be in a state of being impregnated into the positive electrode and the negative electrode within the secondary battery.

The aqueous solvent is a solvent including water, and may be formed of water alone or a combination of water and a solvent other than water. Examples of the solvent other than water include a water-soluble organic solvent. Examples of the water-soluble organic solvent include γ-butyrolactone, acetonitrile, alcohols, N-methylpyrrolidone (NMP), dimethylacetamide, dimethylsulf oxide, tetrahydrofuran, and the like. The above-mentioned solvents may be contained in the aqueous solvent of the aqueous electrolyte singly or in combination of two or more. In the aqueous solvent, the content of the solvent other than water is desirably 20 mass % or less.

The aqueous electrolyte is prepared by dissolving electrolyte salt in the aqueous solvent at a concentration of 1 mol/L to 14 mol/L, for example. The concentration of lithium ions in the aqueous electrolyte is preferably 6 M (mol/L) or more. Thereby, the ion conductivity of the aqueous electrolyte is improved, and the output of the battery is improved. Further, as the lithium salt concentration increases, the coordination number of lithium atoms per water molecule increases. Thus, the coordination structure is stabilized and electrolysis reaction of water is suppressed, which leads to improvement in charge-discharge efficiency and life performance.

Examples of the lithium salt include LiCl, LiBr, LiOH, Li₂SO₄, LiNO₃, lithium bis (trifluoromethanesulfonyl) imide (LiTFSI: LiN(SO₂CF₃)₂), lithium bis (fluorosulfonyl) imide (LiFSI: LiN(SO₂F)₂), lithium bis oxalate borate (LiBOB: LiB [(OCO)₂]₂), and the like. The above-mentioned lithium salt may be used singly or in combination of two or more. In addition, the aqueous electrolyte may contain an additive other than the lithium salt. Examples of the additive include an additive containing the second metallic element MB such as ZnCl₂, PbCl₂, CdCl₂, InCl₃, SnCl₂, BiCl₃, HgCl₂, AlCl₃, or ZnSO₄, for example.

The additive containing these second metallic elements M_{B} may decrease from the added amount by about 0.0001 mol/L to 0.1 mol/L after aging, but does not greatly vary from the added amount.

The aqueous electrolyte may further contain a sodium salt. Examples of the sodium salt include NaCl, Na₂SO₄, NaOH, NaNO₃, NaTFSA (sodium trifluoromethanesulfonylamide), and the like. The above-mentioned sodium salt may be used singly or in combination of two or more.

Examples of the polymeric material include polyvinylidene fluoride (PVdF), polyacrylonitrile (PAN), polyethylene oxide (PEO), and the like. The content of the polymeric material in the electrolyte is, for example, in a range of 0.5 mass % or more and 10 mass % or less.

The pH value of the aqueous electrolyte may be pH 1 to 14. The pH value is preferably pH 3 to 13, and more preferably pH 4 to 12. On one hand, when the pH value is extremely low, hydrogen is generated at the negative electrode due to electrolysis reaction of water. On the other hand, when the pH value is extremely high, oxygen is generated at the positive electrode due to electrolysis reaction of water. When the pH value is extremely high or low as described above, gas is generated within the battery, which impairs the charge-discharge efficiency and the life performance. However, with the pH value in the above-described range, electrolysis reaction of water can be satisfactorily suppressed. The pH value referred to herein means a pH value at 25° C.

The aqueous electrolyte may be divided into an electrolyte for a positive-electrode side and an electrolyte for a negative-electrode side. When the aqueous electrolyte is divided between the positive-electrode side and the negative-electrode side, a partition for avoiding mixing of both sides may be provided, or a separator functioning as a partition maybe used. For the positive-electrode side and the negative-electrode side, the same aqueous electrolyte may be used, or aqueous electrolytes having different compositions or the like may be used.

With regard to the aqueous electrolyte on the negative-electrode side, when its pH is 7 or more, hydrogen generation reaction caused by electrolysis is further suppressed. With regard to the aqueous electrolyte on the positive-electrode side, when its pH is 7 or less, oxygen generation reaction caused by electrolysis is suppressed. On the other hand, when the pH value is more than 7, proton exchange in the positive electrode can be suppressed, thereby improving the charge-discharge efficiency of the secondary battery. Repetition of charge and discharge of a battery containing an acidic aqueous electrolyte (with pH of less than 7) may cause proton exchange at the positive electrode. When a lithium-ion insertion site present in the positive electrode active material is occupied by protons due to proton exchange, a discharge capacity decreases. Thus, from the viewpoint of suppressing proton exchange in the positive electrode, it is desirable to use an aqueous electrolyte having pH more than 7, and the pH value is preferably 8.0 or more, and more preferably 13.0 or more.

The pH of the electrolyte can be adjusted by using a reagent such as HCl, H₂SO₄, LiOH, NaOH, KOH, a tetraethylamine hydroxide solution, or the like, for example.

Inclusion of water in the aqueous electrolyte can be examined by gas chromatography-mass spectrometry (GC-MS) measurement. Further, the salt concentration and the water content in the aqueous electrolyte can be measured by inductively-coupled plasma (ICP) emission analysis or the like, for example. By weighing a specified amount of the aqueous electrolyte and calculating the concentration of salt contained therein, the molar concentration (mol/L) can be calculated. The concentration of the additive containing the second metallic element M_{B} in the aqueous electrolyte can also be measured by ICP emission spectrometry. Further, by measuring the specific gravity of the aqueous electrolyte, the number of moles of the solute and the solvent can be calculated.

The pH of the aqueous electrolyte can be measured with pH test paper. The pH test paper is immersed in the aqueous electrolyte and drawn out of the electrolyte. The pH test paper is left as it is until a color of a portion subjected to color change has finished changing. After the color change is done, the finally obtained color is compared against a color sample appended to the test paper to determine the pH value.

(4) Separator

The separator is disposed between the negative electrode and the positive electrode, and prevents electrical contact between the negative electrode and the positive electrode.

As the separator, one having a shape capable of having migration of the electrolyte within the separator.

Examples of the separator include a non-woven fabric, a film, a paper sheet, and the like. Examples of the material forming the separator may include polyolefin such as polyethylene and polypropylene, and cellulose. Preferable examples of the separator include a non-woven fabric including cellulose fiber, a porous film including a polyolefin fiber, and the like.

The separator preferably has a porosity of 60% or more. The fiber diameter is preferably 10 μm or less in a separator including fibers. When the fiber diameter is 10 μm or less, the affinity of the separator with the electrolyte is improved, thus resulting in decreased battery resistance. The more preferable range of the fiber diameter is 3 μm or less. The cellulose-including non-woven fabric having a porosity of 60% or more can be well impregnated with the electrolyte. Therefore, by using such a nonwoven fabric, a high output performance can be exhibited spanning from a low temperature to a high temperature. In addition, such a nonwoven fabric does not react with the negative electrode even upon storage for a long time in a charged state, float charging, or overcharge, whereby short-circuiting between the negative electrode and the positive electrode caused by precipitation of dendrites of the lithium metal does not occur. A more preferable range of the porosity is from 62% to 80%.

Further, a separator including a solid electrolyte layer containing a solid electrolyte may also be used. The solid electrolyte layer may contain one species of solid electrolyte or may contain plural species of solid electrolytes. The solid electrolyte layer may be a solid electrolyte composite film containing a solid electrolyte. The solid electrolyte composite film includes, for example, solid-electrolyte particles that are molded in the form of a film using a polymeric binder. The solid electrolyte layer may contain at least one selected from the group consisting of a plasticizer and electrolyte salt. When the solid electrolyte layer contains an electrolyte salt, the alkali metal ion conductivity of the solid electrolyte layer can be further enhanced, for example.

As a solid electrolyte, an inorganic solid electrolyte is preferably used. Examples of the inorganic solid electrolyte include an oxide-based solid electrolyte and a sulfide-based solid electrolyte. As the oxide-based solid electrolyte, a lithium phosphate solid electrolyte having a NASICON structure and represented by a general formula of LiMe₂(PO₄)₃ is preferably used. Me in the formula described above is preferably one or more selected from the group consisting of titanium (Ti), germanium (Ge), strontium (Sr), zirconium (Zr), tin (Sn), and aluminum (Al). The element Me preferably includes Al and one among Ge, Zr, and Ti.

Specific examples of the lithium phosphate solid electrolyte having the NASICON structure include LATP (Li₁₊ₖAlₖTi₂₋ₖ(PO₄)₃), Li₁₊ₖAlₖGe₂₋ₖ(PO₄)₃, and Liₗ₊AlₖZr₂₋ₖ(PO₄)_{3.} In the formulae described above, k falls within the range of 0<k≤5, and preferably falls within the range of 0.1≤k≤0.5. As the solid electrolyte, LATP is preferably used. LATP is excellent in water resistance and is unlikely to undergo hydrolysis within the secondary battery.

In addition to the above lithium phosphoric acid solid electrolyte, examples of the oxide-base solid electrolyte include amorphous LIPON compounds represented by LiₕPOᵢNⱼ where 2.6≤h≤3.5, 1.9≤i≤3.8, and 0.1≤j≤1.3 (e.g., Li_{2.9}PO_{3.3}N_{0.46}); a compound having a garnet structure and represented by La₅₊ₘXₘLa₃₋ₘMαO₁₂ where X is one or more selected from the group consisting of Ca, Sr, and Ba, Mα is one or more selected from the group consisting of Nb and Ta, and 0≤m≤0.5; a compound represented by Li₃Mβ₂₋ₘL₂O₁₂ where Mβ is one or more selected from the group consisting of Ta and Nb, and L may include Zr, and 0≤m≤0.5; a compound represented by Li₇₋₃ₘAlₘLa₃Zr₃O₁₂ where 0≤m≤0.5; and a LLZ compound represented by Li₅₊ₙLa₃Mγ₂₋ₙZrₙO₁₂ where Mγ is one or more selected from the group consisting of Nb and Ta, and 0≤n≤2 (e.g., Li₇La₃Zr₂O₁₂).

In addition, as the solid electrolyte, a sodium-containing solid electrolyte may be used. The sodium-containing solid electrolyte is excellent in the ionic conductivity of sodium ions. Examples of the sodium-containing solid electrolyte include β-alumina, sodium phosphorus sulfides, sodium phosphates, and the like. The sodium ion-containing solid electrolyte is preferably in a form of glass ceramics.

Examples of the polymeric binder include a polyvinyl-based binder, a polyether-based binder, a polyester-based binder, a polyamine-based binder, a polyethylene-based binder, a silicone-based binder, and a polysulfide-based binder.

As the electrolyte salt which may be contained in the solid electrolyte layer, the lithium salt and/or sodium salt that may be contained in the aqueous electrolyte may be used.

The proportion of the electrolyte salt in the solid electrolyte layer is preferably from 0.01% by mass to 10% by mass, and more preferably from 0.05% by mass to 5% by mass. The proportion of the electrolyte salt in the solid electrolyte layer can be calculated by thermogravimetric (TG) analysis.

Inclusion of electrolyte salt in the solid electrolyte layer can be examined by a distribution of alkali metal ions that is obtained by energy dispersive X-ray spectrometry (EDX) on across-section of the solid electrolyte layer, for example. Namely, when the solid electrolyte layer is formed of a material containing no electrolyte salt, alkali metal ions remain in the surface layer of the polymeric material in the solid electrolyte layer, and thus are hardly present inside the solid electrolyte layer. Thus, there can be observed a concentration gradient in which the concentration of alkali metal ions is high near the surface of the solid electrolyte layer, whereas the concentration of alkali metal ions is low inside the solid electrolyte layer. On the other hand, when the solid electrolyte layer is formed of a material containing electrolyte salt, it can be confirmed that alkali metal ions are uniformly present to the extent of the solid electrolyte layer interior.

Meanwhile, in a case where the electrolyte salt contained in the solid electrolyte layer and the electrolyte salt contained in the aqueous electrolyte are of different species, it can be seen from a difference in species of ions present, that the solid electrolyte layer contains electrolyte salt different from that in the aqueous electrolyte. For example, when lithium chloride (LiCl) is used as the aqueous electrolyte and lithium bis (fluorosulfonyl) imide) (LiTFSI) is used for the solid electrolyte layer, presence of (fluorosulfonyl) imide ions can be confirmed in the solid electrolyte layer. On the other hand, in the aqueous electrolyte, presence of (fluorosulfonyl) imide ions cannot be confirmed, or the ions are present at an extremely low concentration.

The separator preferably has a thickness of from 20 μm to 100 μm and a density of from 0.2 g/cm³ to 0.9 g/cm³. When the thickness and the density of the separator are respectively within the above ranges, balance can be maintained between the mechanical strength and a reduction in battery resistance, whereby there can be provided a secondary battery which has a high output and where there is suppression in occurrence of internal short circuits. In addition, there is little thermal shrinkage of the separator at high temperatures, and thus, a favorable high-temperature storage performance can be attained.

(5) Container Member

As the container member that houses the positive electrode, the negative electrode, and the aqueous electrolyte, a metal container, a laminated film container, or a resin container may be used.

As the metal container, a metal can made of nickel, iron, stainless steel, or the like and having a prismatic shape or a cylindrical shape may be used. As the resin container, container made of polyethylene, polypropylene, or the like may be used.

The plate thickness of each of the resin container and the metal container preferably falls within the range of 0.05 mm to 1 mm. The plate thickness is more preferably 0.5 mm or less, and even more preferably 0.3 mm or less.

As the laminated film, for example, a multilayered film formed by covering a metal layer with resin layers may be used. Examples of the metal layer include a stainless steel foil, an aluminum foil, and an aluminum alloy foil. As the resin layer, a polymer such as polypropylene (PP), polyethylene (PE), nylon, or polyethylene terephthalate (PET) may be used.

The thickness of the laminated film preferably falls within the range of 0.01 mm to 0.5 mm. The thickness of the laminated film is more preferably 0.2 mm or less.

(6) Negative Electrode Terminal

The negative electrode terminal preferably includes the first metallic substance, in a similar manner as the negative electrode current collector. For example, a negative electrode terminal made of the first metallic element M_{A} may be used.

Other than that, there may be used for the negative electrode terminal, a material that is electrochemically stable at the potential of alkali metal ion insertion/extraction of the negative electrode active material and has electrical conductivity, for example. Specifically, the material other than the first metallic substance for the negative electrode terminal may include zinc, zinc alloy, stainless steel, aluminum, or an aluminum alloy containing at least one selected from the group consisting of Mg, Ti, Zn, Mn, Fe, Cu, and Si. Among them, zinc or a zinc alloy is preferably used as the material for the negative electrode terminal. In order to reduce the contact resistance between the negative electrode terminal and the negative electrode current collector, the negative electrode terminal is preferably made of the same material as that of the negative electrode current collector.

(7) Positive Electrode Terminal

The positive electrode terminal is made, for example, of a material that is electrically stable in a potential range of 3 V to 4.5 V with respect to oxidation-reduction potential of lithium (vs. Li/Li⁺) and has electrical conductivity. Examples of the material for the positive electrode terminal include titanium, aluminum, or an aluminum alloy containing at least one selected from a group consisting of Mg, Ti, Zn, Mn, Fe, Cu, and Si. In order to reduce the contact resistance between the positive electrode terminal and the positive electrode current collector, the positive electrode terminal is preferably made of the same material as that of the positive electrode current collector.

The secondary battery according to the embodiment may be used in various forms such as a prismatic shape, a cylindrical shape, a flat form, a thin form, and a coin form. In addition, the secondary battery may be a secondary battery having a bipolar structure. A secondary battery having a bipolar structure has an advantage of being able to fabricate a cell with in-series connection of multiple, using a single cell.

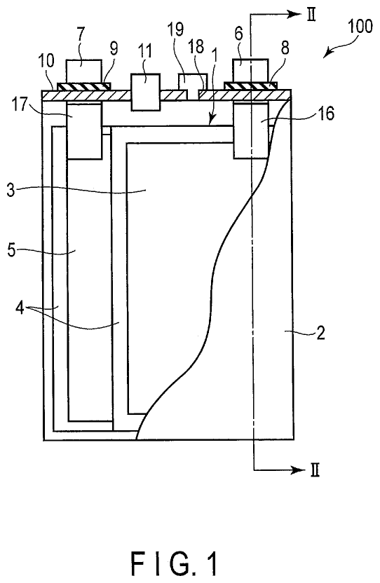

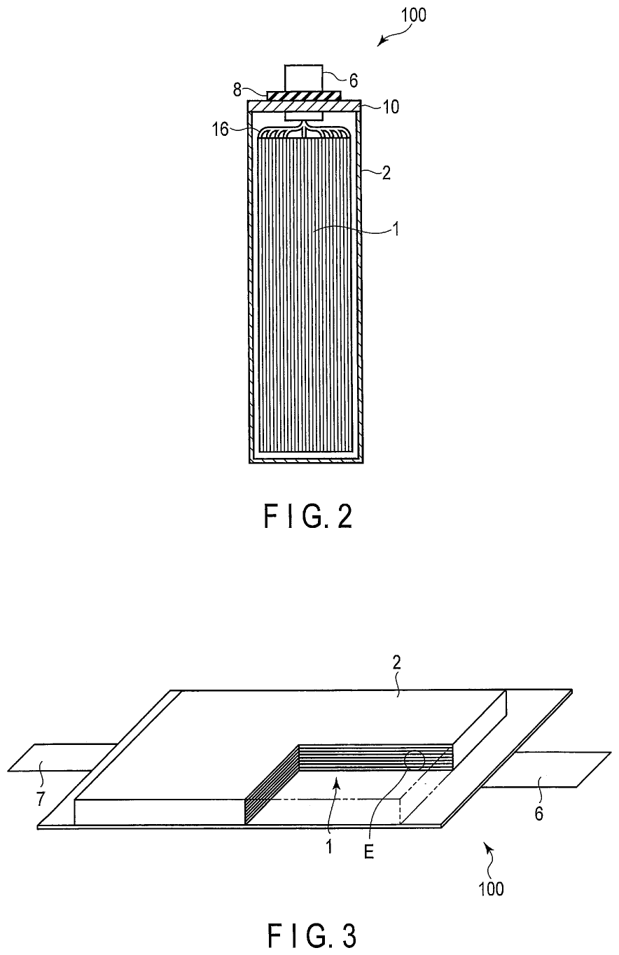

Details of the secondary battery according to the embodiment will be described below with reference to FIGS. 1 and 2. FIG. 1 is a sectional view schematically showing an example of the secondary battery according to the embodiment. FIG. 2 is a schematic sectional view of the secondary battery shown in FIG. 1 taken along a line II-II.

An electrode group 1 is housed in a container member 2 made of a rectangular tubular metal container. The electrode group 1 includes a negative electrode 3, a separator 4, and a positive electrode 5. The electrode group 1 has a structure formed by spirally winding the positive electrode 5 and the negative electrode 3 with the separator 4 interposing therebetween so as to form a flat shape. An aqueous electrolyte (not shown) is held by the electrode group 1. As shown in FIG. 1, a strip-shaped negative electrode lead 16 is electrically connected to each of plural portions at an end of the negative. electrode 5 located on an end face of the electrode group 1. In addition, a strip-shaped positive electrode lead 17 is electrically connected to each of plural portions at an end of the positive electrode 5 located on the end face. The plural negative electrode leads 16 are electrically connected to a negative electrode terminal 6 in a bundled state, as shown in FIG. 2. In addition, the plural positive electrode leads 17 are similarly electrically connected to a positive electrode terminal 7 in a bundled state, although not shown.

A sealing plate 10 made of metal is fixed to the opening portion of the container member 2 made of metal by welding or the like. The negative electrode terminal 6 and the positive electrode terminal 7 are extracted to the outside from outlet holes provided in the sealing plate 10, respectively. On the inner surfaces of the outlet holes of the sealing plate 10, a negative electrode gasket 8 and a positive electrode gasket 9 are arranged to avoid a short circuit caused by contact respective with the negative electrode terminal 6 and the positive electrode terminal 7. By providing the negative electrode gasket 8 and the positive electrode gasket 19, the airtightness of the secondary battery 100 can be maintained.

A control valve 11 (safety valve) is provided on the sealing plate 10. When the internal pressure of the battery cell is raised by gas generated by electrolysis of the aqueous solvent, the generated gas can be released from the control valve 11 to the outside. As the control valve 11 there may be used, for example, a return type valve that operates when the internal pressure exceeds a predetermined value and functions as a sealing plug when the internal pressure lowers. Alternatively, there maybe used a non-return type valve that cannot recover the function as a sealing plug once it operates. In FIG. 1, the control valve 11 is disposed at the center of the sealing plate 10. However, the position of the control valve 11 may be an end of the sealing plate 10. The control valve 11 may be omitted.

Additionally, an inlet 18 is provided on the sealing plate 10. The aqueous electrolyte may be put in via the inlet 18. The inlet 18 may be closed with a sealing plug 19 after the aqueous electrolyte is put in. The inlet 18 and the sealing plug 19 may be omitted.

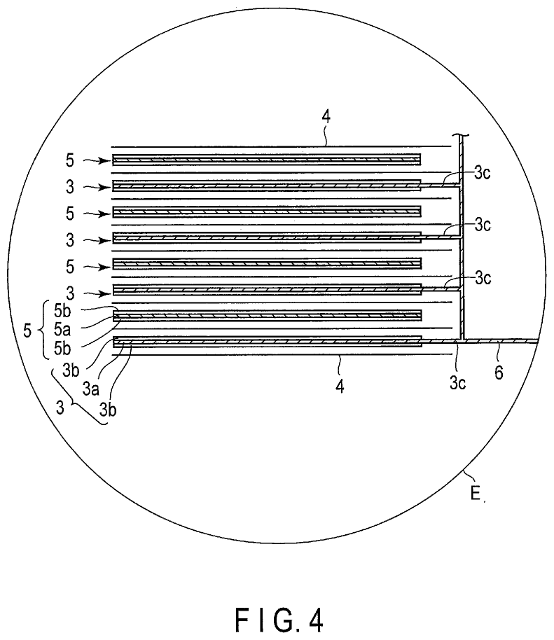

FIG. 3 is a partially cut out perspective view schematically showing another example of the secondary battery according to the embodiment. FIG. 4 is an enlarged sectional view of section E of the secondary battery shown in FIG. 3. FIG. 3 and FIG. 4 show an example of the secondary battery 100 using a laminated film container member as a container.

The depicted secondary battery 100 includes an electrode group 1, a container member 2, and an aqueous electrolyte, which is not shown. The electrode group 1 and the aqueous electrolyte are housed in the container member 2. The aqueous electrolyte is held in the electrode group 1.

The container member 2 is made of a laminated film including two resin layers and a metal layer sandwiched between the resin layers.

As shown in FIG. 4, the electrode group 1 is a stacked electrode group. The stacked electrode group 1 has a structure in which negative electrodes 3 and positive electrodes 5 are alternately stacked with separator(s) 4 sandwiched therebetween.

The electrode group 1 includes plural negative electrodes 3. Each of the negative electrodes 3 includes a negative electrode current collector 3a and negative electrode active material-containing layers 3b supported on both surfaces of the negative electrode current collector 3a. The electrode group 1 further includes plural positive electrodes 5. Each of the positive electrodes 5 includes a positive electrode current collector 5a and positive electrode active material-containing layers 5b supported on both surfaces of the positive electrode current collector 5a.

The negative electrode current collector 3a of each of the negative electrodes 3 includes at one end, a portion 3c where the negative electrode active material-containing layer 3b is not supported on any surface. The portion 3c serves as a negative electrode current collecting tab. As shown, the portion 3c serving as the negative electrode current collecting tab 3c does not overlap the positive electrode 5. Plural negative electrode current collecting tabs (portions 3c) are electrically connected to a belt-shaped negative electrode terminal 6. A leading end of the belt-shaped negative electrode terminal 6 is drawn to the outside from the container member 2.

Although not shown, the positive electrode current collector 5a of each of the positive electrodes 5 includes at one end a portion where the positive electrode active material-containing layer 5b is not supported on any surface. This portion serves as a positive electrode current collecting tab. Like the negative electrode current collecting tab (portion 3c), the positive electrode current collecting tab does not overlap the negative electrode 3. Further, the positive electrode current collecting tab is located on the opposite side of the electrode group 1 with respect to the negative electrode current collecting tab (portion 3c). The positive electrode current collecting tab is electrically connected to a belt-shaped positive electrode terminal 7. A leading end of the belt-shaped positive electrode terminal 7 is located on the opposite side of the negative electrode terminal 6 and drawn to the outside from the container member 2.

<Production Method>

The secondary battery according to the embodiment can be produced as follows.

The aqueous electrolyte, the positive electrode, and the negative electrode formed using the negative electrode current collector containing the first metallic element M_{A} are prepared. A battery is assembled using the aqueous electrolyte, the positive electrode, and the negative electrode. An additive containing the second metallic element M_{B} is added to the aqueous electrolyte. The additive containing the second metallic element M_{B} is added to the aqueous electrolyte in an amount of 0.001 mass % or more and 1 mass % or less (with respect to the mass of the aqueous electrolyte), for example, though the amount fluctuates depending on the unit weight of the negative electrode active material-containing layer to be coated and the liquid amount of the electrolyte.

After the battery is assembled, aging is performed under different conditions depending on the dissolution potential of the first metallic element M_{A}, to elute a part of the first metallic element M_{A} from the current collector. There are mainly three parameters of a negative electrode potential (vs. SCE), an electrode temperature, and a potential retention time. The amount of dissolution from the current collector can be increased by increasing at least one of the potential, the electrode temperature, and the potential retention time. The negative electrode potential is adjusted to a range of −1.4 V (vs. SCE) or higher and +1 V (vs. SCE) or lower, the temperature is adjusted to a range of 25° C. or higher and 80° C. or lower, and the retention time is adjusted to 30 minutes or longer and 24 hours or shorter. If any of them is too high or too long, dissolution from the negative electrode current collector proceeds too far, to disable the function as a negative electrode current collector. Further, for coating the active material-containing layer, as well, too high a potential or temperature and too long a retention time are not preferable because the amount of the first metallic substance derived from the negative electrode current collector would be excessive, which causes an increase in resistance.

Following the first aging of eluting the first metallic element M_{A}, the negative electrode potential, the electrode temperature, and the potential retention time are readjusted to carry out second aging for depositing the first metallic substance and the second metallic substance onto the surface of the negative electrode active material-containing layer. In the second aging, a source of the first metallic substance eluted into the electrolyte by the first aging is deposited onto the surface of the negative electrode active material-containing layer to form the first metallic substance. At the same time, the additive containing the second metallic element M_{B} in the electrolyte that is a source of the second metallic substance is deposited onto the surface of the negative electrode active material-containing layer to form the second metallic substance. The first metallic substance derived from the current collector and the second metallic substance derived from the electrolyte additive are formed on the surface of the negative electrode active material-containing layer while being mixed with each other, which suppresses the added metal from undergoing dendrite growth or becoming acicular, thereby enabling uniform coating.

In the second aging, the negative electrode potential is adjusted to a range of −1.6 V (vs. SCE) or higher and −0.5 V (vs. SCE) or lower, the temperature is adjusted to a range of 15° C. or higher and 80° C. or lower, and the retention time is adjusted to 30 minutes or longer and 24 hours or shorter. By performing the first aging under the above-described appropriate conditions and appropriately adjusting conditions for the second aging, it is possible to obtain a desired value for the ratio P_{A}/P_{A}+P_{B}) of the abundances of the first metallic substance and the second metallic substance. From the viewpoint of promoting deposition of the first and second metallic substances, the negative electrode potential is preferably adjusted to a low value. However, when the negative electrode potential is low, hydrogen is more apt to be generated. In order to suppress hydrogen generation that is a competing reaction to the deposition reaction, the temperature is preferably lowered in a case where the negative electrode potential is adjusted to a low value. In a case where coating is performed with a metal species of which deposition proceeds even at a relatively high potential, uniform coating can be promoted by an increase of the temperature.

Specifically, for example, in a case where a Sn foil is used as the negative electrode current collector, the negative electrode potential after the battery assembly is set to about −1.1 V (vs. SCE). Though there are some variances depending on the ion concentration, the pH, the temperature and the like in the aqueous electrolyte, the dissolution potential of Sn is about −1.0 V (vs SCE), and thus the metal Sn begins to dissolve gradually at about −1.0 V (vs. SCE). It is possible to achieve elution of the metal from the current collector to the liquid electrolyte by holding the battery at that potential at 25° C. for three hours. Thereafter, by holding the battery at a negative electrode potential of −1.5 V (vs. SCE) at 30° C. for 24 hours, a desired value of the ratio P_{A}/(P_{A}+P_{B}) can be achieved.

Additionally, in a case where the negative electrode potential is not adjusted immediately after the battery assembly, the negative electrode potential takes the following numerical values, for example, depending mainly on the material of the negative electrode current collector:

Negative electrode containing a Sn current collector: −1.2 V (vs. SCE)

Negative electrode containing a Pb current collector: −1.2 V (vs. SCE)

Negative electrode containing a Cu current collector: −1.0 V (vs. SCE)

Negative electrode containing a Ni current collector: −1.3 V (vs. SCE).

<Measurement Method>

Various measurement methods will be described. Specifically, there will be described a method of measuring the ratio P_{A}/(P_{A}+P_{B}) of the first and second metallic elements on the surface of the negative electrode active material-containing layer, the first metallic substance in the current collector, the dissolution level of the first metallic substance, the hydrogen generation potential in the negative electrode, and the active material contained in the negative electrode.

(Method of Measuring Abundance of First Metallic Element M_{A} and Second Metallic Element M_{B})

The ratio P_{A}/(P_{A}+P_{B}) of the abundance P_{A} of the first metallic element M_{A} and the abundance P_{B} of the second metallic element M_{B} on the surface of the negative electrode active material-containing layer is measured by a combination of observation and analysis using a scanning electron microscope (SEM) and analysis using energy dispersive X-ray spectroscopy (EDX), as follows.

First, the secondary battery is disassembled. For example, after the secondary battery having been subjected to initial charge is discharged, the battery is disassembled and the negative electrode is taken out. The taken-out negative electrode is washed with pure water for 30 minutes. Thereafter, vacuum drying is performed in a temperature environment of 80° C. for 24 hours. After drying, the temperature is returned to 25° C., and a negative electrode sample is obtained.

The obtained negative electrode sample is analyzed using a SEM image described below to clarify the structural characteristics of the surface of the active material-containing layer.

As a SEM apparatus, SU 8020 manufactured by Hitachi High-Tech Corporation is used, for example. For image analysis, software appended to SU 8020 is used. The conditions for analysis in SEM observation are as follows:

Instruction Name=SU 8000

Data Number=SU 8020

Signal Name=LA 100 (U)

SE Det Setting=LA-BSE, U, Even, VSE=100

Accelerating Voltage=3000 V

Deceleration Voltage=0 V

Magnification=50,000 times

Working Distance=2600 μm

Lens Mode=High.

Subsequently, the amount of elements on the surface of the negative electrode can be quantitatively analyzed by EDX. The abundance P_{A} of the first metallic element M_{A} and the abundance P_{B} of the second metallic element M_{B} are each calculated as an elemental ratio (mol %).

(Method of Measuring Coverage of Negative Electrode Active Material-Containing Layer with First and Second Metallic Substances)

The coverage of the surface of the negative electrode active material-containing layer with the first metallic substance and the second metallic substance can be measured as follows.

First, the secondary battery is disassembled. The battery is discharged and disassembled by the same procedure as described above, and the negative electrode is taken out, washed, and dried, to obtain a negative electrode sample.

An image of the surface of the negative electrode active material-containing layer of the negative electrode sample observed at a magnification of 1000 is divided in 10×10 for a total of 100 sections, and EDX mapping is performed in each section. A section in which a value of the sum of the abundances P_{A}+P_{B} of the first and second metallic elements is less than 1% is regarded as an uncovered section, and a section in which the value of P_{A}+P_{B} is 1% or more is regarded as a covered section. Based on the measured 100 sections, calculation is performed according to the following equation.

coverage (%)=[(covered sections/100)×100%]

(Method of Measuring Absolute Amounts of First and Second Metallic Elements on Surface of Negative Electrode Active Material-Containing Layer)

The absolute amounts of the first metallic element M_{A} and the second metallic element M_{B} contained on the surface of the negative electrode active material-containing layer can be measured as follows.

First, the secondary battery is disassembled. For example, after the secondary battery having been subjected to initial charge is discharged, the battery is disassembled and the negative electrode is taken out. The taken-out negative electrode is washed with pure water three times and dried at 120° C. for 12 hours or more to obtain a negative electrode sample.

The obtained negative electrode sample is processed by ion milling to expose a cross-section of the electrode. The cross-section is divided along the depth direction into three portions of a surface portion, an intermediate portion, and a portion near the current collector, and EDX mapping is performed in each portion, to measure the abundances of the first metallic element M_{A} and the second metallic element M_{B} in the surface portion (P_{A-1}, P_{B-1}), the intermediate portion (P_{A-2}, P_{B-2}), and the portion near the current collector (P_{A-3}, P_{B-3}). The abundances near the surface in the active material-containing layer are measured from each of the obtained abundances P by the following formulae.

Abundance P_{A-S} of the first metallic element M_{A} in the surface portion=P_{A-1}/(P_{A-1}+P_{A-2} +P_{A-3})

Abundance P_{B-S} of the second metallic element M_{B} in the surface portion=P_{B-1}/(P_{B-1}+P_{B-2}+P_{B-3})

Subsequently, the current collector is removed from the negative electrode washed with pure water three times and dried at 120° C. for 12 hours or more following disassembly of the battery as described above, and thus the active material-containing layer is provided alone. Using the active material-containing layer, the absolute amount of the first metallic element M_{A} contained in the whole of the active material-containing layer and the second metallic element M_{B} in the surface portion is measured by inductively-coupled plasma (ICP). By multiplying the measured absolute amounts respectively by P_{A-S} and P_{B-S} obtained by the above-described calculation, the absolute amounts of the first metallic element M_{A} and the second metallic element M_{B} contained in the surface layer portion can be measured.

(Method of Measuring First Metallic Substance Contained in Current Collector)

The first metallic substance contained in the negative electrode current collector can be measured by inductively coupled plasma (ICP) emission spectroscopy.

First, the secondary battery is disassembled. For example, after the secondary battery already subjected to initial charge is discharged, the battery is disassembled and the negative electrode is taken out. The taken-out negative electrode is washed with pure water or N-methyl-2 pyrrolidone (NMP) for 30 minutes. The negative electrode active material-containing layer taken off, and thus the negative electrode current collector is provided alone. The negative electrode current collector is vacuum-dried in a temperature environment of 80° C. for 24 hours to obtain a current collector sample.

The obtained current collector sample is subjected to ICP measurement, so that it can be examined whether or not the first metallic substance is contained. Further, the first metallic substance contained in the current collector sample can be identified.

(Method of Measuring Dissolution Level of First Metallic Substance)

The dissolution level of the first metallic substance in the aqueous electrolyte at a potential of −1.2 V (vs. SCE) is measured as follows.

First, the secondary battery is disassembled. For example, after the secondary battery having been subjected to initial charge is discharged, the battery is disassembled and the negative electrode is taken out. The taken-out negative electrode is washed with pure water or N-methyl-2 pyrrolidone (NMP) for 30 minutes. The negative electrode active material-containing layer is taken off, and thus the negative electrode current collector is provided alone. The negative electrode current collector is vacuum-dried in a temperature environment of 80° C. for 24 hours to obtain a current collector sample. Further, the aqueous electrolyte is collected from the disassembled secondary battery.

The mass of the obtained current collector sample is measured. The current collector sample is then connected to a working electrode of a potentiostat. A platinum wire is connected as a counter electrode, and a standard calomel electrode is used as a reference electrode. The current collector sample, the platinum wire, and the standard calomel electrode are immersed in the aqueous electrolyte collected from the secondary battery. At that time, the contact area between the current collector sample and the electrolyte is calculated. A voltage of −1.2 V with respect to the standard calomel electrode is applied to the current collector sample, and the current collector sample is taken out 169 hours later. The mass of the current collector sample is measured again. Using the masses before and after voltage application, the dissolution level is determined by the following equation.

$$Dissolution Level ( \% ) = [ 1 - ( \frac{\begin{matrix}mass after \\ voltage application\end{matrix}}{\begin{matrix}mass before \\ voltage application\end{matrix}} ) ] \times 100 \%$$

(Method of Measuring Hydrogen Generation Potential in Negative Electrode)

A hydrogen generation potential (V vs. SCE) at the negative electrode is measured as follows.

First, the secondary battery is disassembled. For example, after the secondary battery already subjected to initial charge is discharged, the battery is disassembled and the negative electrode is taken out. The taken-out negative electrode is washed with pure water for 30 minutes. Thereafter, vacuum drying is performed in a temperature environment of 80° C. for 24 hours. After drying, the temperature is returned to 25° C., and a negative electrode sample is obtained (the active material-containing layer is not taken off). Further, the aqueous electrolyte is collected from the disassembled secondary battery.

The negative electrode sample is connected to a working electrode of a potentiostat. A platinum wire is connected as a counter electrode, and a standard calomel electrode is used as a reference electrode. The current collector sample, the platinum wire, and the standard calomel electrode are immersed in the aqueous electrolyte collected from the secondary battery. Sweep is performed at a potential of the working electrode from 0 V to −2.0 V with respect to the standard calomel electrode at a speed of 1 mV/sec, to measure a current density (mA/cm²). The value of the potential (V vs. standard calomel electrode) provided when the value of the current density reaches 1 mA/cm² is recorded as a hydrogen generation potential.

(Measurement of Negative Electrode Active Material)

The negative electrode active material included in the negative electrode can be identified by combining elemental analysis with a scanning electron microscope equipped with an energy dispersive X-ray spectrometry scanning apparatus (scanning electron microscope-energy dispersive X-ray spectrometry; SEM-EDX), ICP emission spectrometry, and X-ray diffraction (XRD) measurement. By SEM-EDX analysis, shapes of components contained in the active material-containing layer and composition ratios of the components contained in the active material-containing layer (each element from B to U in the periodic table) can be known. The elements in the active material-containing layer can be quantified by ICP measurement. Crystal structures of materials included in the active material-containing layer can be examined by XRD measurement.

First, the secondary battery is disassembled. For example, after the secondary battery already subjected to initial charge is discharged, the battery is disassembled and the negative electrode is taken out. The taken-out negative electrode is washed with pure water for 30 minutes. Thereafter, vacuum drying is performed in a temperature environment of 80° C. for 24 hours. After drying, the temperature is returned to 25° C., and a negative electrode sample is obtained.

A cross-section of the negative electrode sample is cutout by Ar ion milling. The cutout cross-section is observed with the SEM. Sampling is performed in an inert atmosphere such as argon or nitrogen to avoid exposing the sample to the air. Several particles are selected from SEM images at 3000-fold magnification. Here, particles are selected such that a particle diameter distribution of the selected particles becomes as wide as possible.

Next, elemental analysis is performed on each selected particle by EDX. Accordingly, it is possible to specify kinds and quantities of elements other than Li among the elements contained in each selected particle.

With regard to Li, information regarding the Li content in the entire active material can be obtained by ICP emission spectrometry. ICP emission spectrometry is performed according to the following procedure.

From the dried negative electrode, a powder sample is prepared in the following manner. The negative electrode active material-containing layer is dislodged from the negative electrode current collector and ground in a mortar. The ground sample is dissolved with acid to prepare a liquid sample. Here, hydrochloric acid, nitric acid, sulfuric acid, hydrogen fluoride, and the like may be used as the acid. The components included in the active material being measured can be found by subjecting the liquid sample to ICP analysis.

Crystal structure(s) of compound(s) included in each of the particles selected by SEM can be specified by XRD measurement. XRD measurement is performed within a measurement range where 2θ is from 5 degrees to 90 degrees, using CuKα ray as a radiation source. By this measurement, X-ray diffraction patterns of compounds contained in the selected particles can be obtained.

As an apparatus for XRD measurement, SmartLab manufactured by Rigaku is used, for example. Measurement is performed under the following conditions:

X ray source: Cu target

Output: 45 kV, 200 mA

soller slit: 5 degrees in both incident light and received light

step width (2θ): 0.02 deg

scan speed: 20 deg/min

semiconductor detector: D/teX Ultra 250

sample plate holder: flat glass sample plate holder (0.5 mm thick)

measurement range: range of 5°≤2θ≤90°

When another apparatus is used, measurement using a standard Si powder for powder X-ray diffraction is performed, so as to find conditions that provide measurement results of peak intensity, half width, and diffraction angle that are equivalent to the results obtained by the above apparatus, and measurement of the sample is performed with those conditions.

Conditions of the XRD measurement is set, such that an XRD pattern applicable to Rietveld analysis is obtained. In order to collect data for Rietveld analysis, specifically, the step width is made ⅓to ⅕of the minimum half width of the diffraction peaks, and the measurement time or X-ray intensity is appropriately adjusted in such a manner that the intensity at the peak position of strongest reflected intensity is 5,000 cps or more.

The XRD pattern obtained as described above is analyzed by the Rietveld method. In the Rietveld method, the diffraction pattern is calculated from the crystal structure model that has been estimated in advance. Here, estimation of the crystal structure model is performed based on analysis results of EDX and ICP. The parameters of the crystal structure (lattice constant, atomic coordinate, occupancy ratio, or the like) can be precisely analyzed by fitting all the calculated values with the measured values.

XRD measurement can be performed with the negative electrode sample directly attached onto a glass holder of a wide-angle X-ray diffraction apparatus. At this time, an XRD spectrum is measured in advance in accordance with the species of metal foil as the negative electrode current collector, and the position(s) of appearance of the peak(s) derived from the collector is grasped. In addition, the presence/absence of peaks) of mixed substances such as an electro-conductive agent or a binder is also grasped in advance. If the peak (s) of the current collector overlaps the peak(s) of the active material, it is desirable to perform measurement with the active material-containing layer removed from the current collector. This is in order to separate the overlapping peaks when quantitatively measuring the peak intensities. If the overlapping peaks can be grasped beforehand, the above operations can be omitted, of course.

The secondary battery according to a first embodiment includes an aqueous electrolyte, a positive electrode, and a negative electrode. The positive electrode and the negative electrode are in contact with the aqueous electrolyte. The negative electrode includes a negative electrode current collector and a negative electrode active material-containing layer disposed thereon. The negative electrode current collector includes a first metallic substance including the above-described first metallic element M_{A}. The negative electrode active material-containing layer includes on a surface thereof, the first metallic substance and a second metallic substance including the above-described second metallic element M_{B}. A ratio P_{A}/(P_{A}+P_{B}) concerning an abundance P_{A} of the first metallic element M_{A} and an abundance P_{B}, of the second metallic element M_{B} at the surface of the negative electrode active material-containing layer is 0.01 or more. The secondary battery can exhibit excellent charge-discharge efficiency and excellent life performance.

### Second Embodiment

According to a second embodiment, a battery module is provided. The battery module includes plural of secondary batteries according to the first embodiment.

In the battery module, each of the single-batteries may be arranged to be electrically connected in series or in parallel, or may be arranged in combination of in-series connection and in-parallel connection.

An example of the battery module will be described next with reference to the drawings.

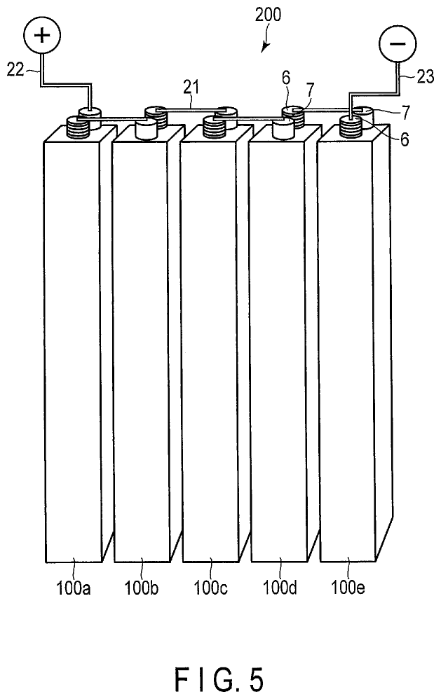

FIG. 5 is a perspective view schematically showing an example of the battery module. The battery module 200 shown in FIG. 5 includes five single-batteries 100a to 100e, four bus bars 21, a positive electrode-side lead 22, and a negative electrode-side lead 23. Each of the five single-batteries 100a to 100e is the secondary battery according to the first embodiment.

The bus bar 21 connects, for example, a negative electrode terminal 6 of one single-battery 100a and a positive electrode terminal 7 of the single-battery 100b positioned adjacent. In such a manner, five single-batteries 100 are thus connected in series by the four bus bars 21. That is, the battery module 200 shown in FIG. 5 is a battery module of five in-series connection. Although no example is depicted in drawing, in a battery module including plural single-batteries that are electrically connected in parallel, for example, the plural single-batteries may be electrically connected by having plural negative electrode terminals being connected to each other by bus bars while having plural positive electrode terminals being connected to each other by bus bars.

The positive electrode terminal 7 of at least one battery among the five single-batteries 100a to 100e is electrically connected to the positive electrode-side lead 22 for external connection. In addition, the negative electrode terminal 6 of at least one battery among the five single-batteries 100a to 100e is electrically connected to the negative electrode-side lead 23 for external connection.

The battery module according to the embodiment includes a secondary battery according to an embodiment. Therefore, the battery module can exhibit excellent charge-discharge efficiency and life performance.

### Third Embodiment

According to a third embodiment, provided is a battery pack including the secondary battery according to the first embodiment. The battery pack may include a battery module according to the second embodiment. The battery pack may include a single secondary battery according to the first embodiment, in place of the battery module according to the second embodiment.

The battery pack may further include a protective circuit. The protective circuit has a function to control charging and discharging of the secondary battery. Alternatively, a circuit included in equipment where the battery pack serves as a power source (for example, electronic devices, vehicles, and the like) may be used as the protective circuit for the battery pack.

Moreover, the battery pack may further include an external power distribution terminal. The external power distribution terminal is configured to externally output electric current from the secondary battery, and/or to input external electric current into the secondary battery. In other words, when the battery pack is used as a power source, electric current is provided out via the external power distribution terminal. When the battery pack is charged, the charging current (including regenerative energy of motive force of vehicles such as automobiles) is provided to the battery pack via the external power distribution terminal.

Next, an example of a battery pack according to the embodiment will be described with reference to the drawings.

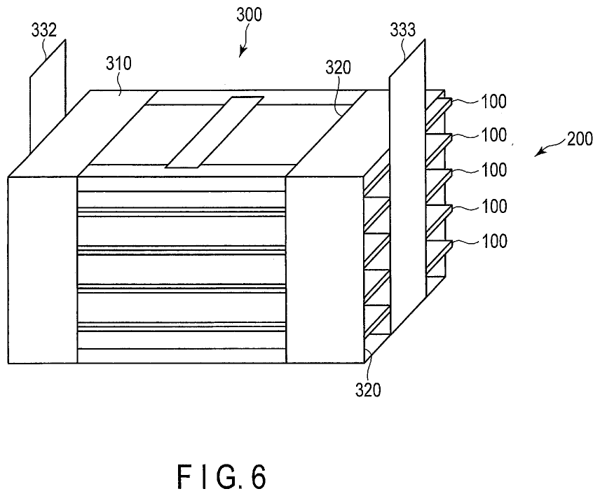

FIG. 6 is a perspective view schematically showing an example of the battery pack according to the embodiment.

A battery pack 300 includes a battery module configured of the secondary battery shown in FIGS. 3 and 4. The battery pack 300 includes a housing 310, and a battery module 200 housed in the housing 310. In the battery module 200, plural (for example, five) secondary batteries 100 are electrically connected in series. The secondary batteries 100 are stacked in a thickness direction. The housing 310 has an opening 320 on each of an upper portion and four side surfaces. The side surfaces, from which the positive and negative electrode terminals 6 and 7 of the secondary batteries 100 protrude, are exposed through the opening 320 of the housing 310. A positive electrode terminal 332 for output of the battery module 200 is belt-shaped, and one end thereof is electrically connected to any or all of the positive electrode terminals 7 of the secondary batteries 100, while the other end protrudes beyond the opening 320 of the housing 310 and thus protrudes past the upper portion of the housing 310. Meanwhile, a negative electrode terminal 333 for output of the battery module 200 is belt-shaped, and one end thereof is electrically connected to any or all of the negative electrode terminals 6 of the secondary batteries 100, while the other end protrudes beyond the opening 320 of the housing 310 and thus protrudes past the upper portion of the housing 310.

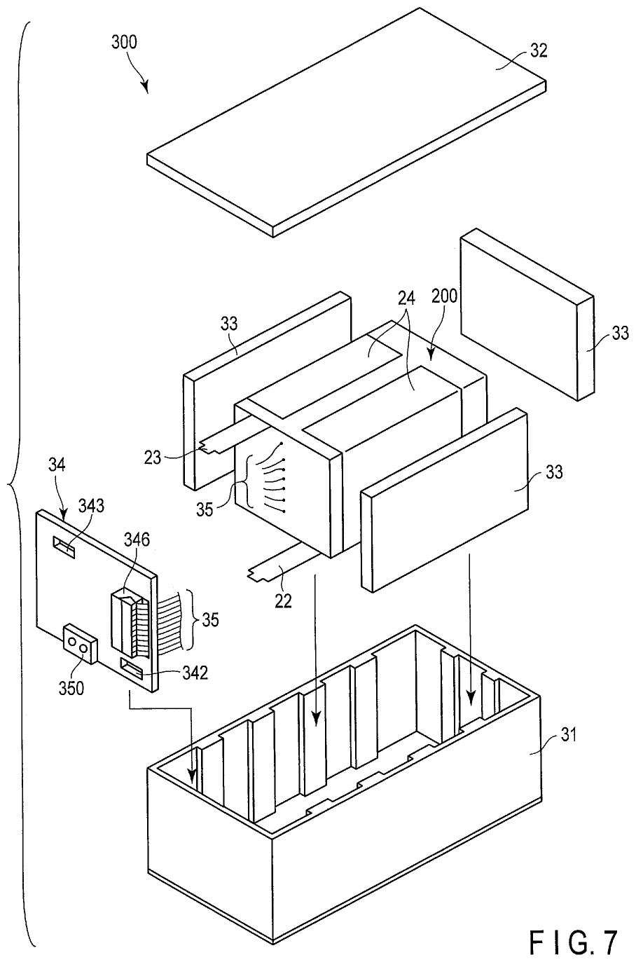

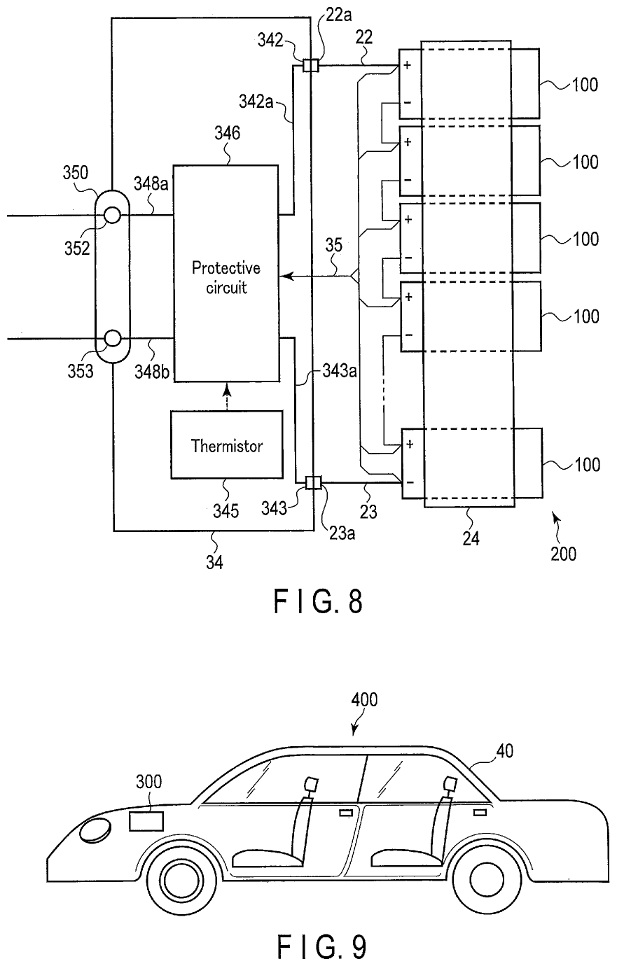

Another example of the battery pack is explained in detail with reference to FIG. 7 and FIG. 8. FIG. 7 is an exploded perspective view schematically showing another example of the battery pack according to the embodiment. FIG. 8 is a block diagram showing an example of an electric circuit of the battery pack shown in FIG. 7.

An illustrated battery pack 300 includes a housing container 31, a lid 32, protective sheets 33, a battery module 200, a printed wiring board 34, wires 35, and an insulating plate (not shown).

The illustrated housing container 31 is a square-bottomed container having a rectangular bottom surface. The housing container 31 is configured to be capable of housing the protective sheets 33, the battery module 200, the printed wiring board 34, and the wires 35. The lid 32 has a rectangular shape. The lid 32 covers the housing container 31 to house the battery module 200 and such. Although not illustrated, the housing container 31 and the lid 32 are provided with openings, connection terminals, or the like for connection to an external device or the like.

The battery module 200 includes plural single-batteries 100, a positive electrode-side lead 22, a negative electrode-side lead 23, and adhesive tape(s) 24.

At least one of the plural single-batteries 100 is a secondary battery according to the embodiment. The plural single-batteries 100 are electrically connected in series, as shown in FIG. 8. The plural single-batteries 100 may alternatively be electrically connected in parallel, or connected in a combination of in-series connection and in-parallel connection. If the plural single-batteries 100 are connected in parallel, the battery capacity increases as compared to a case in which they are connected in series.

The adhesive tape(s) 24 fastens the plural single-batteries 100. The plural single-batteries 100 may be fixed using a heat shrinkable tape in place of the adhesive tape(s) 24. In this case, protective sheets 33 are arranged on both side surfaces of the battery module 200, and the heat shrinkable tape is wound around the battery module 200 and protective sheets 33. After that, the heat shrinkable tape is shrunk by heating to bundle the plural single-batteries 100.

One end of the positive electrode-side lead 22 is connected to the battery module 200. The one end of the positive electrode-side lead 22 is electrically connected to the positive electrode(s) of one or more single-battery 100. One end of the negative electrode-side lead 23 is connected to the battery module 200. The one end of the negative electrode-side lead 23 is electrically connected to the negative electrode (s) of one or more single-battery 100.

The printed wiring board 34 is provided along one face in the short side direction among the inner surfaces of the housing container 31. The printed wiring board 34 includes a positive electrode-side connector 342, a negative electrode-side connector 343, a thermistor 345, a protective circuit 346, wirings 342a and 343a, an external power distribution terminal 350, a plus-side wiring (positive-side wiring) 348a, and a minus-side wiring (negative-side wiring) 348b. One principal surface of the printed wiring board 34 faces one side surface of the battery module 200. An insulating plate (not shown) is disposed in between the printed wiring board 34 and the battery module 200.

The other end 22a of the positive electrode-side lead 22 is electrically connected to the positive electrode-side connector 342. The other end 23a of the negative electrode-side lead 23 is electrically connected to the negative electrode-side connector 343.

The thermistor 345 is fixed to one principal surface of the printed wiring board 34. The thermistor 345 detects the temperature of each single-battery 100 and transmits detection signals to the protective circuit 346.

The external power distribution terminal 350 is fixed to the other principal surface of the printed wiring board 34. The external power distribution terminal 350 is electrically connected to device(s) that exists outside the battery pack 300. The external power distribution terminal 350 includes a positive-side terminal 352 and a negative-side terminal 353.

The protective circuit 346 is fixed to the other principal surface of the printed wiring board 34. The protective circuit 346 is connected to the positive-side terminal 352 via the plus-side wiring 348a. The protective circuit 346 is connected to the negative-side terminal 353 via the minus-side wiring 348b. In addition, the protective circuit 346 is electrically connected to the positive electrode-side connector 342 via the wiring 342a. The protective circuit 346 is electrically connected to the negative electrode-side connector 343 via the wiring 343a. Furthermore, the protective circuit 346 is electrically connected to each of the plural single-batteries 100 via the wires 35.

The protective sheets 33 are arranged on both inner surfaces of the housing container 31 along the long side direction and on the inner surface along the short side direction facing the printed wiring board 34 across the battery module 200. The protective sheets 33 are made of, for example, resin or rubber.

The protective circuit 346 controls charge and discharge of the plural single-batteries 100. The protective circuit 346 is also configured to cut-off electric connection between the protective circuit 346 and the external power distribution terminal 350 (positive-side terminal 352, negative-side terminal 353) to external device(s), based on detection signals transmitted from the thermistor 345 or detection signals transmitted from each single-battery 100 or the battery module 200.

An example of the detection signal transmitted from the thermistor 345 is a signal indicating that the temperature of the single-battery(s) 100 is detected to be a predetermined temperature or more. An example of the detection signal transmitted from each single-battery 100 or the battery module 200 include a signal indicating detection of over-charge, over-discharge, and overcurrent of the single-battery(s) 100. When detecting over charge or the like for each of the single-batteries 100, the battery voltage may be detected, or a positive electrode potential or negative electrode potential may be detected. In the latter case, a lithium electrode to be used as a reference electrode may be inserted into each single-battery 100.

Note, that as the protective circuit 346, a circuit included in a device (for example, an electronic device or an automobile) that uses the battery pack 300 as a power source may be used.

As described above, the battery pack 300 includes the external power distribution terminal 350. Hence, the battery pack 300 can output electric current from the battery module 200 to an external device and input electric current from an external device to the battery module 200 via the external power distribution terminal 350. In other words, when using the battery pack 300 as a power source, the electric current from the battery module 200 is supplied to an external device via the external power distribution terminal 350. When charging the battery pack 300, a charge current from an external device is supplied to the battery pack 300 via the external power distribution terminal 350. If the battery pack 300 is used as an onboard battery, the regenerative energy of the motive force of a vehicle can be used as the charge current from the external device.

Note that the battery pack 300 may include plural battery modules 200. In this case, the plural battery modules 200 may be connected in series, in parallel, or connected in a combination of in-series connection and in-parallel connection. The printed wiring board 34 and the wires 35 may be omitted. In this case, the positive electrode-side lead 22 and the negative electrode-side lead 23 may respectively be used as the positive-side terminal and negative-side terminal of the external power distribution terminal.

Such a battery pack 300 is used, for example, in applications where excellent cycle performance is demanded when a large current is extracted. More specifically, the battery pack 300 is used as, for example, a power source for electronic devices, a stationary battery, or an onboard battery for various kinds of vehicles. An example of the electronic device is a digital camera. The battery pack 300 is particularly favorably used as an onboard battery.

The battery pack according to the third embodiment is provided with the secondary battery according to the first embodiment or the battery module according to the second embodiment. Accordingly, the battery pack can exhibit excellent charge-discharge efficiency and excellent life performance.

### Fourth Embodiment

According to a fourth embodiment, provided is a vehicle including the battery pack according to the third embodiment.

In the vehicle, the battery pack is configured, for example, to recover regenerative energy from motive force of the vehicle. The vehicle may include a mechanism (e.g., a regenerator) for converting kinetic energy of the vehicle into regenerative energy.

Examples of the vehicle according to the embodiment include two- to four-wheeled hybrid electric automobiles, two-to four-wheeled electric automobiles, power assisted bicycles, and railway cars.

In the vehicle according to the embodiment, the installing position of the battery pack is not particularly limited. For example, the battery pack may be installed in the engine compartment of the vehicle, in rear parts of the vehicle, or under seats.

The vehicle according to the embodiment may have plural battery packs installed thereon. In such a case, batteries included in each of the battery packs may be electrically connected to each other in series, electrically connected in parallel, or electrically connected in a combination of in-series connection and in-parallel connection. For example, in a case where each battery pack includes a battery module, the battery modules may be electrically connected to each other in series, electrically connected in parallel, or electrically connected in a combination of in-series connection and in-parallel connection. Alternatively, in a case where each battery pack includes a single battery, each of the batteries may be electrically connected to each other in series, electrically connected in parallel, or electrically connected in a combination of in-series connection and in-parallel connection.

Next, an example of the vehicle according to the embodiment will be described with reference to the drawings.

FIG. 9 is a partially see-through diagram schematically showing an example of a vehicle according to the embodiment.

The illustrated vehicle 400 includes a vehicle body 40 and a battery pack 300 according to the third embodiment. In the example shown, the vehicle 400 is a four-wheeled automobile.

This vehicle 400 may have plural battery packs 300 installed. In such a case, the batteries (single-batteries or battery modules) included in the battery packs 300 may be connected in series, connected in parallel, or connected in a combination of in-series connection and in-parallel connection.

In FIG. 9, the battery pack 300 is installed in an engine compartment located at the front of the vehicle body 40. As described above, the battery pack 300 maybe installed in rear sections of the vehicle body 40, or under a seat. The battery pack 300 may be used as a power source of the vehicle 400. In addition, the battery pack 300 can recover regenerative energy of a motive force of the vehicle 400.

The vehicle according to the fourth embodiment has the battery pack according to the third embodiment installed therein. Therefore, the vehicle is excellent in drive performance and reliability.

### Fifth Embodiment

According to a fifth embodiment, provided is a stationary power supply including the battery pack according to the third embodiment.

The stationary power supply may have the battery module according to the second embodiment or the secondary battery according to the first embodiment installed therein, instead of the battery pack according to the third embodiment. The stationary power supply can realize high efficiency and long life.

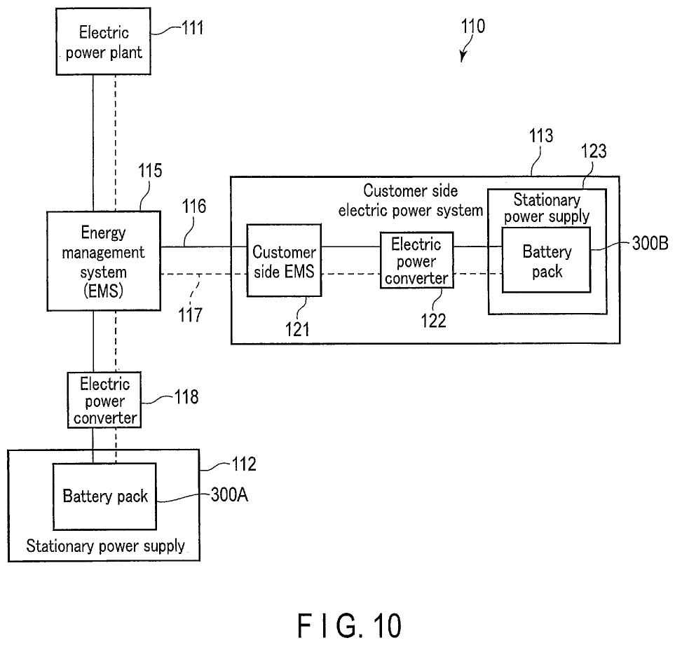

FIG. 10 is a block diagram showing an example of a system including the stationary power supply according to the embodiment. FIG. 10 is a diagram showing an application example to stationary power supplies 112, 123 as an example of use of battery packs 300A, 300B according to an embodiment. In the example shown in FIG. 10, shown is a system 110 in which the stationary power supplies 112, 123 are used. The system 110 includes an electric power plant 111, the stationary power supply 112, a customer side electric power system 113, and an energy management system (EMS) 115. Also, an electric power network 116 and a communication network 117 are formed in the system 110, and the electric power plant 111, the stationary power supply 112, the customer side electric power system 113 and the EMS 115 are connected via the electric power network 116 and the communication network 117. The EMS 115 performs control to stabilize the entire system 110 by utilizing the electric power network 116 and the communication network 117.

The electric power plant 111 generates a large capacity of electric power from fuel sources such as thermal power or nuclear power. Electric power is supplied from the electric power plant 111 through the electric power network 116 and the like. In addition, the battery pack 300A is installed in the stationary power supply 112. The battery pack 300A can store electric power and the like supplied from the electric power plant 111. In addition, the stationary power supply 112 can supply the electric power stored in the battery pack 300A through the electric power network 116 and the like. The system 110 is provided with an electric power converter 118. The electric power converter 118 includes a converter, an inverter, a transformer and the like. Thus, the electric power converter 118 can perform conversion between direct current (DC) and alternate current (AC), conversion between alternate currents of frequencies different from each other, voltage transformation (step-up and step-down) and the like. Therefore, the electric power converter 118 can convert electric power from the electric power plant 111 into electric power that can be stored in the battery pack 300A.

The customer side electric power system 113 includes an electric power system for factories, an electric power system for buildings, an electric power system for home use and the like. The customer side electric power system 113 includes a customer side EMS 121, an electric power converter 122, and the stationary power supply 123. The battery pack 300B is installed in the stationary power supply 123. The customer side EMS 121 performs control to stabilize the customer side electric power system 113.

Electric power from the electric power plant 111 and electric power from the battery pack 300A are supplied to the customer side electric power system 113 through the electric power network 116. The battery pack 300B can store electric power supplied to the customer side electric power system 113. Similarly to the electric power converter 118, the electric power converter 122 includes a converter, an inverter, a transformer and the like. Thus, the electric power converter 122 can perform conversion between direct current and alternate current, conversion between alternate currents of frequencies different from each other, voltage transformation (step-up and step-down) and the like. Therefore, the electric power converter 122 can convert electric power supplied to the customer side electric power system 113 into electric power that can be stored in the battery pack 300B.

Note that the electric power stored in the battery pack 300B can be used, for example, for charging a vehicle such as an electric automobile. Also, the system 110 may be provided with a natural energy source. In such a case, the natural energy source generates electric power by natural energy such as wind power and solar light. In addition to the electric power plant 111, electric power is also supplied from the natural energy source through the electric power network 116.

### EXAMPLES

Examples will be described below, but the embodiments are not limited to the examples described below.

### Example 1

A secondary battery was produced by the following procedure.

<Fabrication of Positive Electrode>

As a positive electrode active material, a lithium-manganese oxide (LiMn₂O₄) having a spinel structure was used. Graphite powder was used as an electro-conductive agent, and polyvinylidene fluoride (PVdF) was used as a binder. The positive electrode active material, the electro-conductive agent, and the binder were blended in proportions of 80 mass %, 10 mass %, and 10 mass %, respectively, and dispersed in an N-methyl-2 pyrrolidone (NMP) solvent to prepare a slurry. The prepared slurry was applied onto both sides of a Ti foil having a thickness of 12 μm as a positive electrode current collector, and the resultant coating film was dried to form a positive electrode active material-containing layer. The positive electrode current collector and the positive electrode active material-containing layer on the collector were subjected to a pressing process, thereby forming a positive electrode having an electrode density of 3.0 g/cm³ (not including the current collector).

<Fabrication of Negative Electrode>

As a negative electrode active material, Li₄Ti₅O₁₂ powder having a spinel structure was used. Graphite powder was used as an electro-conductive agent, and polyvinylidene fluoride (PVdF) was used as a binder. The negative electrode active material, the electro-conductive agent, and the binder were blended in proportions of 80 mass %, 10 mass %, and 10 mass %, respectively, and dispersed in an NMP solvent to prepare a slurry. The prepared slurry was applied onto a Sn foil having a thickness of 50 μm as a negative electrode current collector, and the resultant coating film was dried to form a negative electrode active material-containing layer. When applying the slurry onto the Sn foil, the slurry was applied only onto one surface of the Sn foil for a portion of the negative electrode being fabricated that would be located outermost in an electrode group, whereas the slurry was applied onto both surfaces of the Sn foil for the other portions. The negative electrode current collector and the negative electrode active material-containing layer on the collector were subjected to a pressing process, thereby forming a negative electrode having an electrode density of 2.0 g/cm³ (not including the current collector).

<Fabrication of Electrode Group and Housing of Electrode in Container>

The positive electrode fabricated in the above-described manner, a nonwoven-fabric separator that is formed of a cellulose fiber and has a thickness of 20 μm, the negative electrode fabricated in the above-described manner, and another nonwoven-fabric separator were stacked in this order, to form a stack. Subsequently, the stack was spirally wound so that the negative electrode was located outermost, to form an electrode group. The formed electrode group was hot-pressed at 90° C. to form a flat electrode group. The obtained electrode group was housed in a container including a thin metal can formed of stainless steel having a thickness of 0.25 mm. As the metal can, a metal can provided with a valve that leaks gas when its internal pressure becomes equal to two atmospheres or more was used.

<Preparation of Electrolyte>

A solution was prepared by dissolving 12 mol/L of LiCl in water. Then, ZnCl₂ in an addition amount of 0.01 mol/L with respect to the mass of the solution was added to the solution. The pH of the liquid electrolyte prepared in the above-described manner was measured with universal test paper, whereupon the pH was 7.

<Assembly and Aging of Battery>

The prepared electrolyte was put into the container housing the electrode group, and the container was subjected to temporary sealing. Immediately after the temporary sealing, charge and discharge were performed to adjust the negative electrode potential to −1 V (vs. SCE) with respect to the standard calomel electrode. With the negative electrode potential adjusted in the above-described manner, first aging was performed in an environment of 25° C. for three hours. Thereafter, the negative electrode potential was adjusted to −1.5 V (vs. SCE) with respect to the standard calomel electrode, and second aging in which the battery was held in an environment of 30° C. for 24 hours was performed.

The assembled battery was subjected to aging in the above manner, whereby a secondary battery according to Example 1 was obtained.

### Examples 2 to 60

Secondary batteries were produced by the same procedures as that in Example 1 except that the materials and conditions were changed as shown in Tables 1 and 2 shown below. Specifically, the material of the negative electrode current collector (material containing the first metallic element M_{A}), the additive to the electrolyte (additive containing the second metallic element M_{B}) and the amount thereof, and the aging conditions were changed to those shown in Tables 1 and 2. The aging conditions include a negative electrode potential (vs. SCE), a temperature, and time in each of the first aging of eluting the first metallic substance and the second aging of depositing the first metallic substance and the second metallic substance. Additionally, although the pH of the liquid electrolyte before the first aging was measured with universal test paper, the pH was 7 in every example.

### Comparative Example 1

A secondary battery was produced by the same procedure as that in Example 1 except that the aging (both the first aging and the second aging) was omitted. The negative electrode current collector was a tin foil and potential adjustment was not performed. Thus, the negative electrode potential in the assembled secondary battery was −1.2 V (vs. SCE).

### Comparative Example 2

A secondary battery was produced by the same procedure as that in Example 1 except that the additive to the electrolyte was changed to the material shown in Table 2 and the aging was omitted in the same manner as in Example 1. The negative electrode current collector was a tin foil and potential adjustment was not performed. Thus, the negative electrode potential in the assembled secondary battery was −1.2 V (vs. SCE).

### Comparative Example 3

A secondary battery was produced by the same procedure as that in Example 1 except that the material of the negative electrode current collector was changed to the material shown in Table 2 and the aging was omitted in the same manner as in Comparative Example 1. The negative electrode current collector was an aluminum foil and potential adjustment was not performed. Thus, the negative electrode potential in the assembled secondary battery was −1.0 V (vs. SCE).

### Comparative Example 4

A secondary battery was produced by the same procedure as that in Example 1 except that the material of the negative electrode current collector was changed to the material shown in Table 2 and the aging conditions were changed to the conditions shown in Table 2. More specifically, a copper foil was used for the negative electrode current collector. Additionally, since aging was performed in a 25° C. environment for 24 hours without potential adjustment after the battery assembly, it can be considered that only the second aging was performed. Since the negative electrode current collector was a tin foil the negative electrode potential in the state without potential adjustment was −1.0 V (vs. SCE).

### Comparative Examples 5 to 7

Secondary batteries were produced by the same procedures as that in Example 1 except that the aging conditions were changed to the conditions shown in Table 1.

The production conditions of the secondary battery in the Examples 1 to 60 and Comparative Examples 1 to 7 are summarized in the following Tables 1 and 2. Specifically, the material of the negative electrode current collector (i.e., the first metallic element M_{A}), the additive to the electrolyte (the additive containing the second metallic element M_{B}) and the amount thereof, the conditions for the first aging (elution process), and the conditions for the second aging (deposition process) are summarized. In detail, the negative electrode potential, treatment time, and treatment temperature in each aging treatment are shown. Cases where no aging treatment was performed are marked as “-”, as there was no applicable condition.

TABLE 1

| | Material of | | | First aging treatment | | | Second aging treatment | | |
|---|---|---|---|---|---|---|---|---|---|
| | negative | | | Negative | | | Negative | | |
| | electrode | Additive | Additive | electrode | | | electrode | | |
| | current | to | concentration | potential | Time | Temperature | potential | Time | Temperature |
| | collector | electrode | (mol/L) | (vs. SCE) | (h) | (° C.) | (vs. SCE) | (h) | (° C.) |
| Example 1 | Sn | ZnCl₂ | 0.01 | −1 V | 3 | 30 | −1.5 V | 24 | 30 |
| Example 2 | Sn | PbCl₂ | 0.02 | −1 V | 3 | 30 | −1.5 V | 24 | 30 |
| Example 3 | Sn | CdCl₂ | 0.02 | −1 V | 3 | 30 | −1.5 V | 24 | 30 |
| Example 4 | Sn | InCl₃ | 0.004 | −1 V | 3 | 30 | −1.5 V | 24 | 30 |
| Example 5 | Sn | BiCl₃ | 0.004 | −1 V | 3 | 40 | −1.5 V | 24 | 30 |
| Example 6 | Sn | HgCl₂ | 0.005 | −1 V | 3 | 30 | −1.5 V | 24 | 30 |
| Example 7 | Sn | AlC1₃ | 0.05 | −1 V | 3 | 30 | −1.5 V | 24 | 30 |
| Example 8 | Pb | ZnCl₂ | 0.01 | −1.1 V | 3 | 25 | −1.5 V | 24 | 30 |
| Example 9 | Pb | CdCl₂ | 0.02 | −1.1 V | 3 | 25 | −1.5 V | 24 | 30 |
| Example 10 | Pb | InCl₃ | 0.004 | −1.1 V | 3 | 25 | −1.5 V | 24 | 30 |
| Example 11 | Pb | SnCl₂ | 0.02 | −1.1 V | 3 | 25 | −1.5 V | 24 | 30 |
| Example 12 | Pb | BiCl₃ | 0.004 | −1.1 V | 3 | 25 | −1.5 V | 24 | 30 |
| Example 13 | Pb | HgCl₂ | 0.005 | −1.1 V | 3 | 25 | −1.5 V | 24 | 30 |
| Example 14 | Pb | AlCl₃ | 0.05 | −1.1 V | 3 | 25 | −1.5 V | 24 | 30 |
| Example 15 | Cu | ZnCl₂ | 0.01 | −0.8 V | 3 | 35 | −1.3 V | 24 | 45 |
| Example 16 | Cu | PbCl₂ | 0.02 | −0.8 V | 3 | 35 | −1.3 V | 24 | 45 |
| Example 17 | Cu | CdCl₂ | 0.02 | −0.8 V | 3 | 35 | −1.3 V | 24 | 45 |
| Example 18 | Cu | InCl₃ | 0.004 | −0.8 V | 3 | 35 | −1.3 V | 24 | 45 |
| Example 19 | Cu | SnCl₂ | 0.02 | −0.8 V | 3 | 35 | −1.3 V | 24 | 45 |
| Example 20 | Cu | BiCl₃ | 0.004 | −0.8 V | 3 | 35 | −1.3 V | 24 | 45 |
| Example 21 | Cu | HgCl₂ | 0.005 | −0.8 V | 3 | 35 | −1.3 V | 24 | 45 |
| Example 22 | Cu | AlCl₃ | 0.05 | −0.8 V | 3 | 35 | −1.3 V | 24 | 45 |
| Example 23 | Ni | ZnCl₂ | 0.01 | −1.2 V | 3 | 25 | −1.55 V | 24 | 20 |
| Example 24 | Ni | PbCl₂ | 0.02 | −1.2 V | 3 | 25 | −1.55 V | 24 | 20 |
| Example 25 | Ni | CdCl₂ | 0.02 | −1.2 V | 3 | 25 | −1.55 V | 24 | 20 |
| Example 26 | Ni | InCl₃ | 0.004 | −1.2 V | 3 | 25 | −1.55 V | 24 | 20 |
| Example 27 | Ni | SnCl₂ | 0.02 | −1.2 V | 3 | 25 | −1.55 V | 24 | 20 |
| Example 28 | Ni | BiCl₃ | 0.004 | −1.2 V | 3 | 25 | −1.55 V | 24 | 20 |
| Example 29 | Ni | HgCl₂ | 0.005 | −1.2 V | 3 | 25 | −1.55 V | 24 | 20 |
| Example 30 | Ni | AlCl₃ | 0.05 | −1.2 V | 3 | 25 | −1.55 V | 24 | 30 |
| Example 31 | Sn | ZnCl₂ | 0.01 | −1 V | 3 | 25 | −1.5 V | 12 | 30 |
| Example 32 | Sn | PbCl₂ | 0.02 | −1 V | 3 | 25 | −1.5 V | 12 | 30 |
| Example 33 | Sn | CdCl₂ | 0.02 | −1 V | 3 | 25 | −1.5 V | 12 | 30 |
| Example 34 | Sn | InCl₃ | 0.004 | −1 V | 3 | 25 | −1.5 V | 12 | 30 |
| Example 35 | Sn | BiCl₃ | 0.004 | −1 V | 3 | 25 | −1.5 V | 24 | 30 |
| Example 36 | Sn | HgCl₂ | 0.005 | −1 V | 3 | 25 | −1.5 V | 12 | 30 |
| Example 37 | Sn | AlCl₃ | 0.05 | −1 V | 3 | 25 | −1.5 V | 12 | 30 |

TABLE 2

| | Material of | | | First aging treatment | | | Second aging treatment | | |
|---|---|---|---|---|---|---|---|---|---|
| | negative | | | Negative | | | Negative | | |
| | electrode | Additive | Additive | electrode | | | electrode | | |
| | current | to | concentration | potential | Time | Temperature | potential | Time | Temperature |
| | collector | electrode | (mol/L) | (vs. SCE) | (h) | (° C.) | (vs. SCE) | (h) | (° C.) |
| Example 38 | Cu | ZnCl₂ | 0.01 | −0.8 V | 3 | 25 | −1.3 V | 24 | 45 |
| Example 39 | Cu | PbCl₂ | 0.02 | −0.8 V | 3 | 25 | −1.3 V | 24 | 45 |
| Example 40 | Cu | CdCl₂ | 0.02 | −0.8 V | 3 | 25 | −1.3 V | 24 | 45 |
| Example 41 | Cu | InCl₃ | 0.004 | −0.8 V | 3 | 25 | −1.3 V | 24 | 45 |
| Example 42 | Cu | SnCl₂ | 0.02 | −0.8 V | 3 | 25 | −1.3 V | 24 | 45 |
| Example 43 | Cu | BiCl₃ | 0.004 | −0.8 V | 3 | 25 | −1.3 V | 24 | 45 |
| Example 44 | Cu | HgCl₂ | 0.005 | −0.8 V | 3 | 25 | −1.3 V | 24 | 45 |
| Example 45 | Cu | AlCl₃ | 0.05 | −0.8 V | 2 | 25 | −1.3 V | 12 | 45 |
| Example 46 | Sn | ZnCl₂ | 0.01 | −1 V | 1 | 25 | −1.5 V | 6 | 30 |
| Example 47 | Sn | PbCl₂ | 0.02 | −1 V | 1 | 25 | −1.5 V | 6 | 30 |
| Example 48 | Sn | CdCl₂ | 0.02 | −1 V | 1 | 25 | −1.5 V | 6 | 30 |
| Example 49 | Sn | InCl₃ | 0.004 | −1 V | 1 | 25 | −1.5 V | 6 | 30 |
| Example 50 | Sn | BiCl₃ | 0.004 | −1 V | 1 | 25 | −1.5 V | 6 | 30 |
| Example 51 | Sn | HgCl₂ | 0.005 | −1 V | 1 | 25 | −1.5 V | 6 | 30 |
| Example 52 | Sn | AlCl₃ | 0.05 | −1 V | 1 | 25 | −1.5 V | 6 | 30 |
| Example 53 | Cu | ZnCl₂ | 0.01 | −0.8 V | 2 | 25 | −1.3 V | 12 | 45 |
| Example 54 | Cu | PbCl₂ | 0.02 | −0.8 V | 2 | 25 | −1.3 V | 12 | 45 |
| Example 55 | Cu | CdCl₂ | 0.02 | −0.8 V | 2 | 25 | −1.3 V | 12 | 45 |
| Example 56 | Cu | InCl₃ | 0.004 | −0.8 V | 2 | 25 | −1.3 V | 12 | 45 |
| Example 57 | Cu | SnCl₂ | 0.02 | −0.8 V | 2 | 25 | −1.3 V | 12 | 45 |
| Example 58 | Cu | BiCl₃ | 0.004 | −0.8 V | 2 | 25 | −1.3 V | 12 | 45 |
| Example 59 | Cu | HgCl₂ | 0.005 | −0.8 V | 2 | 25 | −1.3 V | 12 | 45 |
| Example 60 | Cu | AlCl₃ | 0.05 | −0.8 V | 2 | 25 | −1.3 V | 12 | 45 |
| Comparative | Sn | ZnCl₂ | 0.01 | — | — | — | — | — | — |
| Example 1 | | | | | | | | | |
| Comparative | Sn | PbCl₂ | 0.02 | — | — | — | — | — | — |
| Example 2 | | | | | | | | | |
| Comparative | Al | ZnCl₂ | 0.01 | — | — | — | — | — | — |
| Example 3 | | | | | | | | | |
| Comparative | Cu | ZnCl₂ | 0.01 | — | — | — | −1 V | 24 | 25 |
| Example 4 | | | | | | | | | |
| Comparative | Sn | ZnCl₂ | 0.01 | −1.5 V | 3 | 25 | −1.5 V | 6 | 30 |
| Example 5 | | | | | | | | | |
| Comparative | Sn | ZnCl₂ | 0.01 | −1 V | 3 | −10 | −1.5 V | 6 | 30 |
| Example 6 | | | | | | | | | |
| Comparative | Sn | ZnCl₂ | 0.01 | −1 V | 0.1 | 25 | −1.5 V | 6 | 30 |
| Example 7 | | | | | | | | | |

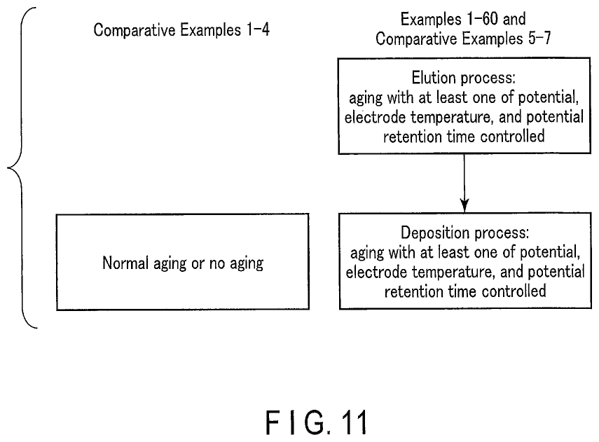

Further, an overview of the aging scheme is illustrated in FIG. 11. As shown in the scheme for Comparative Example 1 to 4 in the left column, in Comparative Examples 1 to 4, the secondary battery was subjected to conventional normal aging or was not subjected to aging at all. Specifically, no aging was performed in Comparative Examples 1 to 3, and normal aging was performed in Comparative Example 4. The “normal aging” used herein refers to a treatment for causing the aqueous electrolyte to permeate into the electrode group and ultimately into the electrode. Because of relatively low permeating property of an aqueous solution into the electrode, absent measures to impregnate the aqueous electrolyte into the electrodes, reduction in initial capacity, an increase in electric resistance, and the like are caused. It may be noted that as a method of performing such normal aging, vacuum impregnation, pressure impregnation, and standing are known. In Examples 1 to 60 and Comparative Example 5 to 7 in the right column, the above-described first aging and second aging of eluting and depositing metal were performed, and at that time, impregnation of the aqueous electrolyte into the electrode was also achieved.

<Measurement>

The secondary batteries according to Examples 1 to 60 and Comparative Examples 1 to 7 were measured according to the procedures described above. Specifically, for each secondary battery, the ratio P_{A}/(P_{A}+P_{B}) of the abundance P_{A} of the first metallic element M_{A} and the abundance P_{B} of the second metallic element M_{B} in the surface of the negative electrode active material, the coverage with the first metallic substance and the second metallic substance, the concentration of the additive containing the second metallic element M_{B} in the electrolyte after aging, the dissolution level of the first metallic substance from the negative electrode current collector at a potential of −1.2 V (vs. SCE) with respect to the standard calomel electrode, and a potential at which hydrogen is generated at the negative electrode, were measured. Additionally, for Comparative Examples 1 to 4, in which neither the first aging nor the second aging was performed, the additive concentration in the electrolyte after aging was not measured. The measurement results are shown in Tables 3 and 4 shown below.

<Evaluation Test>

The secondary batteries according to Examples 1 to 60 and Comparative Examples 1 to 7 were subjected to a constant current charge/discharge test under the following conditions. Both charge and discharge were performed at a 0.5 C rate. Further, for charge, as a condition for terminating charge, the earliest was adopted among when a current value reached 0.25 C, when a charging time reached 130 minutes, and when a charge capacity reached 170 mAh/g. For discharge, duration of 130 minutes after beginning discharge was adopted as a terminating condition.

(Measurement of Coulombic Efficiency)

Performing charge and discharge once under the above-described conditions was set as one cycle. Twenty cycles of repetitive charge and discharge were performed. Coulombic efficiency (charge-discharge efficiency) was calculated from the charge capacity and the discharge capacity in the twentieth cycle by the following equation.

Coulombic efficiency (%)=100%×(discharge capacity/charge capacity)

(Evaluation of Cycling Performance)

Performing charge and discharge once under the above-described conditions was set as one cycle. Twenty cycles of repetitive charge and discharge were performed. The discharge capacity at the twentieth cycle was taken to be 100%, and thereafter, cycles were further repeated. Cycling performance was evaluated based on the number of cycles in which the discharge capacity decreased to 80% or less. A larger number of cycles repeated until the discharge capacity decreased to 80% or less indicates a higher cycling life performance.

The results of the above-described charge-discharge test are shown in the following Tables 3 and 4.

TABLE 3

| | | | | | Dissolution | | |
|---|---|---|---|---|---|---|---|
| | | | | Hydrogen | level of | | |
| | | Coverage with | Additive | generation | negative | | |
| | | first and | concentration | potential | electrode | | Cycling |
| | | second metal | in electrolyte | of negative | current | Coulombic | performance |
| | P_{A}/ | substances | after aging | electrode | collector | efficiency | (number of |
| | (P_{A} + P_{B}) | (%) | (mol/L) | (vs. SCE) | (%) | (%) | cycles) |
| Example 1 | 0.5 | 45 | 0.005 | −1 V | 11 | 95 | 2100 |
| Example 2 | 0.5 | 60 | 0.015 | −1 V | 11 | 94 | 1900 |
| Example 3 | 0.5 | 60 | 0.017 | −1 V | 11 | 92 | 1600 |
| Example 4 | 0.5 | 20 | 0.003 | −1 V | 11 | 90 | 1200 |
| Example 5 | 0.5 | 75 | 0.003 | −1 V | 11 | 92.5 | 1700 |
| Example 6 | 0.5 | 30 | 0.004 | −1 V | 11 | 98 | 2300 |
| Example 7 | 0.5 | 80 | 0.04 | −1 V | 11 | 89 | 1200 |
| Example 8 | 0.5 | 45 | 0.005 | −1.34 V | 5 | 95 | 2800 |
| Example 9 | 0.5 | 60 | 0.017 | −1,34 V | 5 | 92 | 1800 |
| Example 10 | 0.5 | 20 | 0.003 | −1.34 V | 5 | 90 | 1400 |
| Example 11 | 0.5 | 60 | 0.01 | −1.34 V | 5 | 93 | 2000 |
| Example 12 | 0.5 | 20 | 0.003 | −1.34 V | 5 | 92.5 | 1900 |
| Example 13 | 0.5 | 30 | 0.004 | −1.34 V | 5 | 98 | 2500 |
| Example 14 | 0.5 | 80 | 0.04 | −1.34 V | 5 | 89 | 1400 |
| Example 15 | 0.5 | 45 | 0.005 | −0.9 V | 0.1 | 95 | 2800 |
| Example 16 | 0.5 | 60 | 0.015 | −0.9 V | 0.1 | 94 | 2600 |
| Example 17 | 0.5 | 60 | 0.017 | −0.9 V | 0.1 | 92 | 2300 |
| Example 18 | 0.5 | 20 | 0.003 | −0.9 V | 0.1 | 90 | 2000 |
| Example 19 | 0.5 | 60 | 0.01 | −0.9 V | 0.1 | 93 | 2500 |
| Example 20 | 0.5 | 20 | 0.003 | −0.9 V | 0.1 | 92.5 | 2400 |
| Example 21 | 0.5 | 30 | 0.004 | −0.9 V | 0.1 | 98 | 3000 |
| Example 22 | 0.5 | 80 | 0.04 | −0.9 V | 0.1 | 89 | 1900 |
| Example 23 | 0.5 | 45 | 0.005 | −0.7 V | 22 | 95 | 1800 |
| Example 24 | 0.5 | 60 | 0.015 | −0.7 V | 22 | 94 | 1600 |
| Example 25 | 0.5 | 60 | 0.017 | −0.7 V | 22 | 92 | 1300 |
| Example 26 | 0.5 | 20 | 0.003 | −0.7 V | 22 | 90 | 1000 |
| Example 27 | 0.5 | 60 | 0.01 | −0.7 V | 22 | 93 | 1500 |
| Example 28 | 0.5 | 20 | 0.003 | −0.7 V | 22 | 92.5 | 1400 |
| Example 29 | 0.5 | 30 | 0.004 | −0.7 V | 22 | 98 | 2000 |
| Example 30 | 0.5 | 80 | 0.04 | −0.7 V | 22 | 89 | 900 |
| Example 31 | 0.08 | 35 | 0.006 | −1 V | 11 | 94 | 1800 |
| Example 32 | 0.08 | 50 | 0.016 | −1 V | 11 | 93 | 1600 |
| Example 33 | 0.08 | 50 | 0.018 | −1 V | 11 | 91 | 1300 |
| Example 34 | 0.08 | 10 | 0.0035 | −1 V | 11 | 89 | 900 |
| Example 35 | 0.08 | 65 | 0.0035 | −1 V | 11 | 92 | 1400 |
| Example 36 | 0.08 | 20 | 0.0045 | −1 V | 11 | 97 | 2000 |
| Example 37 | 0.08 | 70 | 0.045 | −1 V | 11 | 88 | 900 |

TABLE 4

| | | | | | Dissolution | | |
|---|---|---|---|---|---|---|---|
| | | | | Hydrogen | level of | | |
| | | Coverage by | Additive | generation | negative | | |
| | | first and | concentration | potential | electrode | | Cycling |
| | | second metal | in electrolyte | of negative | current | Coulombic | performance |
| | P_{A}/ | substances | after aging | electrode | collector | efficiency | (number of |
| | (P_{A} + P_{B}) | (%) | (mol/L) | (vs. SCE) | (%) | (%) | cycles) |
| Example 38 | 0.08 | 33 | 0.006 | −0.9 V | 0.1 | 94 | 2500 |
| Example 39 | 0.08 | 48 | 0.016 | −0.9 V | 0.1 | 93 | 2300 |
| Example 40 | 0.08 | 48 | 0.018 | −0.9 V | 0.1 | 91 | 2000 |
| Example 41 | 0.08 | 8 | 0.0035 | −0.9 V | 0.1 | 89 | 1700 |
| Example 42 | 0.08 | 48 | 0.015 | −0.9 V | 0.1 | 92 | 2200 |
| Example 43 | 0.08 | 8 | 0.0035 | −0.9 V | 0.1 | 92 | 2100 |
| Example 44 | 0.08 | 18 | 0.0045 | −0.9 V | 0.1 | 97 | 2700 |
| Example 45 | 0.08 | 68 | 0.045 | −0.9 V | 0.1 | 88 | 1600 |
| Example 46 | 0.03 | 31 | 0.007 | −1 V | 11 | 92 | 1600 |
| Example 47 | 0.03 | 46 | 0.017 | −1 V | 11 | 91 | 1400 |
| Example 48 | 0.03 | 46 | 0.019 | −1 V | 11 | 89 | 1100 |
| Example 49 | 0.03 | 6 | 0.0036 | −1 V | 11 | 87 | 700 |
| Example 50 | 0.03 | 61 | 0 | −1 V | 11 | 90 | 1200 |
| Example 51 | 0.03 | 16 | 0.0046 | −1 V | 11 | 95 | 1800 |
| Example 52 | 0.03 | 66 | 0.046 | −1 V | 11 | 86 | 700 |
| Example 54 | 0.03 | 43 | 0.018 | −0.9 V | 0.1 | 91 | 2100 |
| Example 55 | 0.03 | 43 | 0.019 | −0.9 V | 0.1 | 89 | 1800 |
| Example 56 | 0.03 | 3 | 0.0037 | −0.9 V | 0.1 | 87 | 1500 |
| Example 57 | 0.03 | 43 | 0.017 | −0.9 V | 0.1 | 90 | 2000 |
| Example 58 | 0.03 | 3 | 0.0037 | −0.9 V | 0.1 | 90 | 1900 |
| Example 59 | 0.03 | 13 | 0.0047 | −0.9 V | 0.1 | 95 | 2500 |
| Example 60 | 0.03 | 63 | 0.047 | −0.9 V | 0.1 | 86 | 1400 |
| Comparative | 0.003 | 12 | — | −1 V | 11 | 85 | 200 |
| Example 1 | | | | | | | |
| Comparative | 0.001 | 5 | — | −1 V | 11 | 81 | 150 |
| Example 2 | | | | | | | |
| Comparative | 0 | 0 | — | −0.6 V | 60 | 70 | 120 |
| Example 3 | | | | | | | |
| Comparative | 0 | 0 | — | −0.9 V | 0.1 | 68 | 110 |
| Example 4 | | | | | | | |
| Comparative | 0 | 35 | 0.006 | −1 V | 11 | 65 | 100 |
| Example 5 | | | | | | | |
| Comparative | 0.005 | 42 | 0.006 | −1 V | 11 | 65 | 100 |
| Example 6 | | | | | | | |
| Comparative | 0.004 | 40 | 0.006 | −1 V | 11 | 65 | 100 |
| Example 7 | | | | | | | |

As shown in Tables 3 and 4, in each of the secondary batteries produced in Examples 1 to 60, the ratio P_{A}/(P_{A}+P_{B}) of the abundance P_{A} of the first metallic element M_{A} and the abundance P_{B} of the second metallic element M_{B} at the surface of the negative electrode active material-containing layer was 0.01 or more. In contrast thereto, in each of the secondary batteries produced in Comparative Examples 1 to 7, the ratio P_{A}/(P_{A}+P_{B}) was less than 0.01. In each of Examples 1 to 60, more excellent charge/discharge test results were obtained in terms of both coulombic efficiency and cycling performance than those in Comparative Examples 1 to 7. Therefore, as can be seen from comparison between Examples 1 to 60 and Comparative Examples 1 to 7, the secondary battery having the ratio P_{A}/(P_{A}+P_{B}) of 0.01 or more can exhibit excellent charge-discharge performance and excellent life performance.

In Comparative Examples 1 and 2, due to omission of aging, the first metallic substance had not eluted from the current collector, and as a result, the ratio P_{A}/(P_{A}+P_{B}) was found to be low.

In Comparative Examples 3 and 4, the first aging for elution from the negative electrode current collector can be considered to have been omitted because potential adjustment was not performed. As a result, the ratio P_{A}/(P_{A}+P_{B}) was found to be zero. Additionally, in Comparative Example 3, used for the current collector was an Al foil having a high dissolution level as shown in Table 4 due to its stability in ionic state; even then, due to omission of an elution process, elution and following deposition did not occur.

In Comparative Example 5, due to the extremely low negative electrode potential during the first aging, Sn (regarded as the first metallic substance) had not eluted from the current collector, and as a result, the ratio P_{A}/(P_{A}+Ps) was found to be zero.

In Comparative Example 6, due to the low treatment temperature during the first aging, elution of Sn (regarded as the first metallic substance) from the current collector was kinetically slow, and as a result, the ratio P_{A}/(P_{A}+P_{B}) was found to be low.

In Comparative Example 7, due to the extremely short time of the first aging, there occurred little elution of Sn (regarded as the first metallic substance) from the current collector, and as a result, the ratio P_{A}/(P_{A}+P_{B}) was found to be low.

According to at least one embodiment and example described above, provided is a secondary battery including an aqueous electrolyte, a positive electrode, and a negative electrode. The negative electrode includes a negative electrode current collector including a first metallic substance, and a negative electrode active material-containing layer including the first metallic substance and a second metallic substance on a surface thereof. A ratio P_{A}/P_{A}+P_{B}) of an abundance P_{A} of a first metallic element M_{A} and an abundance P_{B} of a second metallic element M_{B} on the surface of the negative electrode active material-containing layer is 0.01 or more. The secondary battery having the above configuration is excellent in charge-discharge efficiency and life performance, and can provide a battery pack excellent in charge-discharge efficiency and life performance, and a vehicle and stationary power supply having the battery pack installed thereon.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A secondary battery comprising:
an aqueous electrolyte;
a positive electrode in contact with the aqueous electrolyte; and
a negative electrode in contact with the aqueous electrolyte, the negative electrode comprising a negative electrode current collector and a negative electrode active material-containing layer provided on the negative electrode current collector, the negative electrode current collector comprising a first metallic substance, a surface of the negative electrode active material-containing layer comprising the first metallic substance and a second metallic substance, the first metallic substance comprising one or more first metallic element M_{A} selected from the group consisting of Sn, Ni, Cu, Pb, and Ti, the second metallic substance comprising one or more second metallic element M_{B} selected from the group consisting of Hg, Zn, Pb, Sn, Cd, Pd, Al, Bi, and In, and a ratio P_{A}/(P_{A}+P_{B}) of an abundance P_{A} of the first metallic element M_{A} and an abundance P_{B} of the second metallic element M_{B} on the surface of the negative electrode active material-containing layer being 0.01 or more.

2. The secondary battery according to claim 1, wherein a dissolution level of the first metallic substance in the aqueous electrolyte at a potential of −1.2 V (vs. SCE) with respect to a standard calomel electrode is 50% or less.

3. The secondary battery according to claim 1, wherein a hydrogen generation potential at the negative electrode is −0.5 V (vs. SCE) or lower.

4. The secondary battery according to claim 1, wherein the negative electrode active material-containing layer includes a negative electrode active material containing one or more selected from the group consisting of an oxide of titanium, a lithium-titanium oxide, and a lithium-titanium composite oxide.

5. A battery pack comprising the secondary battery according to claim 1.

6. The battery pack according to claim 5, further comprising an external power distribution terminal and a protective circuit.

7. The battery pack according to claim 5, further comprising plural of the secondary battery, the secondary batteries being electrically connected in series, in parallel, or in combination of in-series connection and in-parallel connection.

8. A vehicle comprising the battery pack according to claim 5.

9. The vehicle according to claim 8, which comprises a mechanism configured to convert kinetic energy of the vehicle into regenerative energy.

10. A stationary power supply comprising the battery pack according to claim 5.
